(19) United States
(12) Patent Application Publication
(10) Pub. No.: US 2026/0290064 A1
(43) Pub. Date: Sep. 24, 2026

(54) SYSTEM

(71) Applicant: SoftBank Group Corp., Tokyo (JP)

(72) Inventor: Junya NOMURA, Tokyo (JP)

(73) Assignee: SoftBank Group Corp., Tokyo (JP)

(21) Appl. No.: 19/567,369

(22) Filed: Mar. 16, 2026

(30) Foreign Application Priority Data
Mar. 19, 2025 (JP) 2025-044977

(51) Int. Cl. G06V 30/414; G06F 40/284; G06V 40/16; G10L 15/22

(52) U.S. Cl. CPC G06V 30/414; G06F 40/284; G06V 40/174; G10L 15/22

(57) ABSTRACT

A system includes a processor that is configured to acquire an imaged receipt as digital data and store the imaged receipt in a predetermined storage area, apply optical character recognition to a stored receipt image to extract required information, and analyze voice data and facial expression data of a user, and adjust application content by using a generative artificial intelligence model for determining an emotional state of the user.

### CROSS-REFERENCE TO RELATED APPLICATION

This application is based on and claims priority under 35 USC 119 from Japanese Patent Application No. 2025-044977 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional expense processing systems that handle receipt images typically focus only on optical character recognition of textual information such as dates, amounts, and merchant names. These systems generally acquire an imaged receipt, extract characters, and register the extracted data in an application system in a uniform manner, irrespective of the user's mental or emotional state. However, in practical corporate or organizational workflows, a user's emotional condition during the submission of an application, for example stress, confusion, or hesitation, can result in incomplete, inconsistent, or erroneous application content, such as missing explanations, insufficient justifications, or misclassification of expense types. Existing systems do not take into account voice information or facial expressions of the user at the time of submission and therefore cannot dynamically adapt or adjust the application content in response to the user's emotional state. As a result, there remain issues such as increased burden on approvers, higher rates of correction or resubmission, and reduced overall efficiency and reliability of the expense application process.

### SUMMARY

In order to solve the above-described problems, the present invention provides a system comprising a processor, wherein the processor is configured to acquire an imaged receipt as digital data and store the imaged receipt in a predetermined storage area, apply optical character recognition to a stored receipt image to extract required information, and analyze voice data and facial expression data of a user, and adjust application content by using a generative artificial intelligence model for determining an emotional state of the user. In one aspect, the processor is configured to extract information including at least a date, an amount, and a business operator name from the receipt image. In another aspect, the processor is configured to integrate the extracted information and the receipt image into a data structure, and transmit the data structure to an application system. By combining receipt image acquisition and OCR-based information extraction with analysis of user voice and facial expression data and generative artificial intelligence-based adjustment of application content, the system can automatically tailor and refine the information to be submitted in view of the user's emotional state, thereby reducing errors and omissions, mitigating the burden on approvers, and improving the reliability and efficiency of the overall application process.

The term “system” refers to a combination of hardware components, software components, or a combination thereof, that cooperatively perform the processing defined in the claims, including acquisition, storage, analysis, and transmission of data related to receipt images and user information.

The term “processor” refers to one or more processing units, such as a central processing unit (CPU), a graphics processing unit (GPU), a digital signal processor (DSP), a dedicated integrated circuit, or any combination thereof, configured to execute instructions for performing the functions specified in the claims.

The term “imaged receipt” refers to a receipt that has been captured as an image by a scanner, camera, or similar imaging device, and that represents a physical receipt in a digital image format.

The term “digital data” refers to data expressed in electronic form, including but not limited to image data, text data, audio data, and any combination of these, that is processable by the processor.

The term “predetermined storage area” refers to a logical or physical storage region designated in advance, such as a folder, directory, database, memory area, or cloud storage location, in which the imaged receipt and related data are stored.

The term “stored receipt image” refers to an imaged receipt that has been written to and retained in the predetermined storage area and is accessible for subsequent processing by the processor.

The term “optical character recognition” refers to a technique or process for automatically recognizing and converting characters or text contained in an image, such as a receipt image, into machine-readable character data.

The term “required information” refers to information that is necessary for generating or completing an application, including but not limited to information such as a date, an amount, and a business operator name extracted from a receipt image.

The term “voice data” refers to audio data representing spoken utterances of a user, such as speech captured through a microphone, that can be analyzed by the processor to infer the user's state or intention.

The term “facial expression data” refers to image data, video data, or feature data representing the user's facial expressions, captured by a camera or similar device, and usable by the processor to infer the user's emotional or mental state.

The term “user” refers to a person who operates the system, submits applications, or otherwise interacts with the system, and whose voice data and facial expression data may be analyzed by the processor.

The term “emotional state” refers to a psychological or affective condition of the user, such as stress, anxiety, confusion, satisfaction, or confidence, inferred from voice data and facial expression data.

The term “generative artificial intelligence model” refers to a machine learning model, such as a neural network, transformer model, or other generative model, that is configured to generate, modify, or propose content, including application content, based on input data such as user voice data, facial expression data, and receipt information.

The term “application content” refers to information to be included in an application submitted to an application system, such as expense details, explanations, justifications, or classifications, that can be adjusted or generated by the processor.

The term “date” refers to a calendar date associated with a transaction recorded on a receipt, including at least a year, month, and day, which may be normalized into a standard format by the processor.

The term “amount” refers to a monetary value indicated on a receipt, representing the cost or charge of a transaction, which may be expressed in a specific currency and may be normalized into a numeric representation.

The term “business operator name” refers to a name of an entity, such as a company, store, or service provider, that issued the receipt or provided the goods or services recorded on the receipt.

The term “extracted information” refers to data items obtained by the processor from the receipt image through optical character recognition, including at least the date, amount, and business operator name, and optionally additional items such as tax, currency, or address.

The term “data structure” refers to an organized representation of data, such as a record, object, array, or other logical structure, in which the extracted information and the associated receipt image are integrated for transmission or storage.

The term “application system” refers to an external or separate system, such as an expense management system, approval workflow system, or accounting system, that receives the data structure including the extracted information and receipt image, and processes the data as part of an application or approval process.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

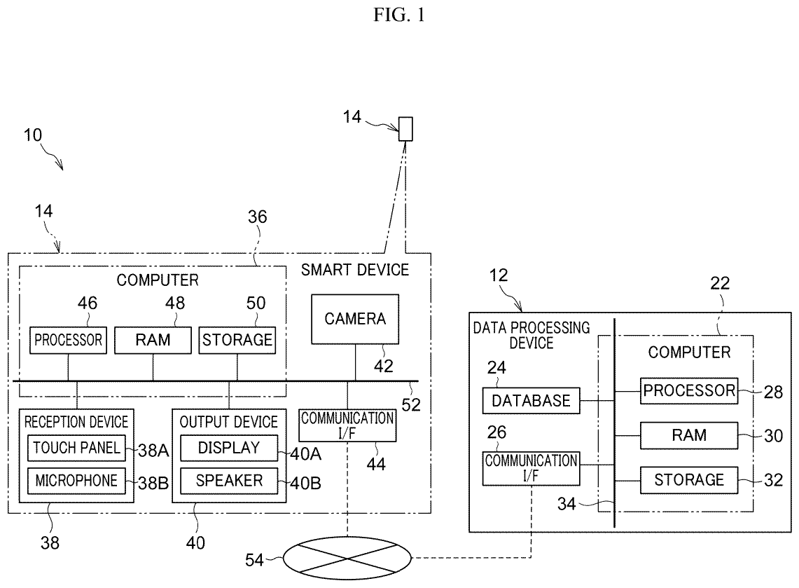

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

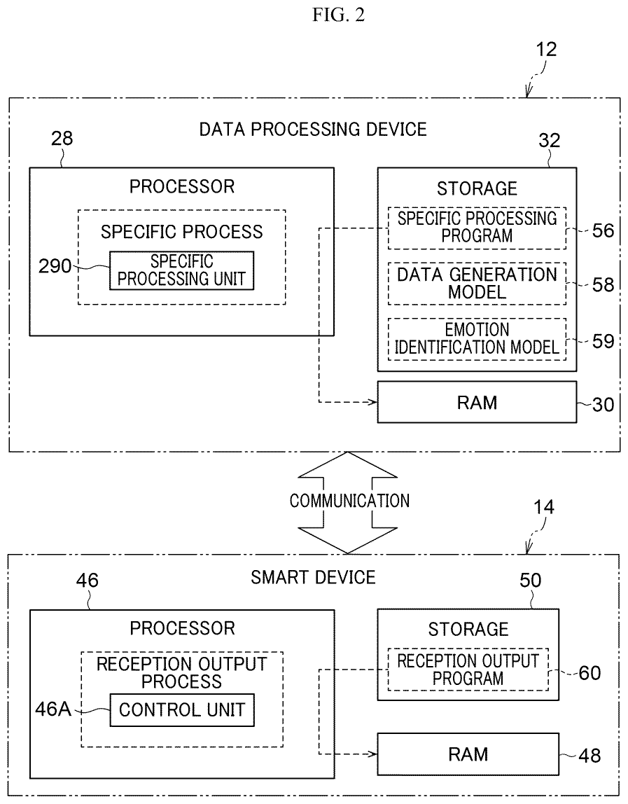

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional receipt processing and application support systems typically treat image acquisition, character recognition, data structuring, and user interaction as loosely coupled, manually orchestrated operations executed by generic computer components. In such systems, receipt images are stored as raw image files, optical character recognition is applied with limited or no preprocessing, and extracted text is handled as unstructured or semi-structured data. As a result, the underlying computer system often suffers from low recognition accuracy, heavy reliance on manual corrections, inefficient storage and retrieval operations, and repeated, redundant processing of image and text data. These inefficiencies manifest as unnecessary memory accesses, increased processor cycles for error handling and reprocessing, and suboptimal use of database indexing and query processing resources. Furthermore, conventional systems that attempt to incorporate user context into application content, such as reimbursement claims or expense reports, typically rely on fixed rules or simple form logic, without dynamically adapting to the user's emotional state or interaction patterns. As a consequence, the computer system fails to leverage available multimodal information (such as voice and facial expression signals) to optimize how application content is generated, adjusted, and stored. This leads to additional back-and-forth corrections, increased network traffic for resubmissions, and degraded overall throughput of the application processing pipeline.

In addition, generative artificial intelligence models are generally invoked as independent services that respond to free-form user queries. This ad hoc usage does not exploit the models as integral components of a structured data processing pipeline. Without a well-defined prompt generation mechanism driven by system state, the computer cannot consistently obtain machine-actionable guidance, such as parameterized adjustment policies or templated application statements. As a result, the system cannot systematically reduce computational overhead associated with repeated manual editing, cannot reliably converge to high-quality application data in fewer processing iterations, and cannot optimize the internal data representations for downstream application processing devices.

Therefore, there is a need for an improved computer-implemented system that tightly integrates (i) structured preprocessing of imaged proof documents, (ii) structured extraction and indexing of receipt-related fields, and (iii) multimodal, generative AI-assisted adjustment of application content based on user emotional state. Such a system should improve the functioning of the computer itself by reducing redundant image and text processing, improving database access efficiency through well-structured and indexed data, and decreasing the number of processing iterations required to reach a stable, high-quality application record, thereby enhancing overall computational efficiency and reliability of the receipt and application processing workflow.

The specific processing by the specific processing unit 290 of the data processing device 12 in Example 1 is realized by the following means.

The present invention provides a server comprising a processor configured to acquire, from an input device, imaged proof documents as electronic data and store the electronic data in a predetermined storage region of a storage device; to execute, on the stored electronic data, a series of predefined preprocessing operations including at least normalization of image features, noise reduction processing, tone correction processing, and skew correction processing so as to generate preprocessed electronic data optimized for optical character recognition; to perform optical character recognition on the preprocessed electronic data to obtain character string information and to analytically extract, from the character string information, structured item information including at least date information, amount information, entity name information, and expense category information; to assign index information to the extracted item information and to store the item information, in association with the preprocessed electronic data, as searchable record information in a database; to acquire voice information and facial expression information from a user associated with the imaged proof documents, convert the voice information and the facial expression information into feature information, and provide the feature information to a generative artificial intelligence model configured to estimate an emotional state; to generate adjustment information for automatically correcting or changing application content on the basis of the estimated emotional state and the structured item information; to generate, in accordance with a system state, a prompt sentence including at least an instruction relating to estimation of the emotional state and adjustment of the application content, provide the prompt sentence to the generative artificial intelligence model, and obtain from the generative artificial intelligence model a generation policy for the adjustment information or a candidate application statement; and to integrate the structured item information, the preprocessed electronic data, the adjustment information, and any obtained candidate application statement into structured data and convert the structured data into a data structure that is transmittable to an external application processing device. This enables the computer system to perform receipt image normalization and optical character recognition with reduced error rates and fewer reprocessing cycles, to maintain application-related data in a highly structured and indexed form that improves database query efficiency and reduces memory and processor overhead, and to leverage multimodal user information together with a generative artificial intelligence model in a deterministic prompt-driven manner so as to minimize manual corrections, reduce network and storage usage associated with repeated submissions, and improve the overall throughput, accuracy, and robustness of computer-implemented application processing.

The term “imaged proof document” refers to a document serving as evidence of a transaction or event, such as a receipt, invoice, or voucher, that has been converted from a physical or electronic original into image data processable by a computer system.

The term “electronic data” refers to information represented in a digital format that can be stored, processed, and transmitted by an electronic device, including but not limited to bitmap images, vector images, text strings, and structured data records.

The term “input device” refers to a hardware component or functional module configured to capture or receive data for processing by a computer system, including but not limited to an image capture device, a scanning device, a microphone, a camera, or a network interface.

The term “storage device” refers to a hardware component or subsystem configured to retain electronic data, including but not limited to a semiconductor memory device, a magnetic storage device, an optical storage device, or a network-based storage service.

The term “storage region” refers to a logically defined portion of a storage device, such as a directory, a file, a memory segment, or an allocated address range, designated to hold particular electronic data used by the system.

The term “preprocessing” refers to a series of operations performed on raw electronic data before a main recognition or analysis task, including one or more of normalization, filtering, enhancement, transformation, or segmentation, to improve the reliability and efficiency of subsequent processing.

The term “normalization of image features” refers to processing that adjusts one or more characteristics of an image, such as size, resolution, aspect ratio, or intensity distribution, to conform to predefined criteria or a standard format suitable for downstream analysis.

The term “noise reduction processing” refers to processing intended to suppress or remove unwanted variations in an image or signal, such as random speckles, compression artifacts, or sensor noise, while preserving meaningful features required for recognition.

The term “tone correction processing” refers to processing that adjusts intensity, contrast, brightness, or related tonal characteristics of an image to enhance the visibility of content such as printed characters or lines.

The term “skew correction processing” refers to processing that detects and compensates for angular misalignment of image content, including rotation of a document image, so that textual lines or structural features are aligned with a reference orientation.

The term “preprocessed electronic data” refers to electronic data that has undergone one or more preprocessing operations so as to enhance its suitability for a subsequent recognition or analysis task, such as optical character recognition.

The term “optical character recognition processing” refers to a computational procedure that analyzes image data containing depictions of characters and outputs machine-readable text data representing the recognized characters.

The term “character string information” refers to a sequence of characters, such as letters, digits, symbols, or punctuation marks, obtained by a recognition process or by other text processing and represented in a computer-readable encoding.

The term “item information” refers to structured information obtained by analyzing character string information, including but not limited to date information, amount information, entity name information, and expense category information.

The term “date information” refers to information representing a calendar date or time-related value associated with a transaction or event, such as a purchase date, issue date, or service date, in any machine-readable format.

The term “amount information” refers to information representing a quantitative monetary value or financial amount associated with a transaction, including optional currency information and numerical formatting.

The term “entity name information” refers to information representing an identifier or designation of an organization, business, or other entity associated with a transaction, such as a merchant name or service provider name.

The term “expense category information” refers to information representing a classification of an expense into one of multiple categories, such as transportation, lodging, meals, or other types of cost, for organizational or accounting purposes.

The term “index information” refers to metadata or structural information associated with stored data, configured to facilitate efficient retrieval, sorting, filtering, or aggregation of records by a database or other storage system.

The term “record information” refers to a logically grouped set of related data elements stored together as a unit, such as a database row or document, that represents an instance of an object or event, for example a single transaction.

The term “database” refers to a structured collection of data organized and managed by a data management component, such as a relational database management system or another structured storage system, enabling query, update, and indexing operations.

The term “voice information” refers to electronic data representing sounds produced by a user, including spoken language and paralinguistic cues, captured by an audio capture device and processed into a format suitable for analysis.

The term “facial expression information” refers to electronic data representing one or more facial features or expressions of a user, captured as image or video data and optionally encoded as feature values for analysis.

The term “feature information” refers to numerical or symbolic representations derived from raw data, such as audio or image data, that capture salient characteristics relevant to a recognition, classification, or estimation task.

The term “generative artificial intelligence model” refers to a machine learning model configured to generate output data, such as text, feature vectors, or other content, in response to input data or prompt sentences, based on parameters learned from training data.

The term “emotional state” refers to a state associated with a user's affect or sentiment, such as satisfaction, frustration, confidence, or uncertainty, which is estimated by computational analysis of multimodal inputs including voice and facial expression.

The term “adjustment information” refers to information defining one or more modifications, corrections, or refinements to application content, such as changes to text, structure, or parameters, derived from analysis of item information and user-related information.

The term “application content” refers to data representing information to be submitted to or processed by an external application processing device, including but not limited to claim details, expense reports, or other structured submissions.

The term “prompt sentence” refers to a text-based instruction, query, or description provided as input to a generative artificial intelligence model to specify a task, constraint, or desired form of output.

The term “generation policy” refers to information specifying rules, preferences, or strategies guiding how a generative artificial intelligence model produces output, such as which elements to emphasize, adjust, or omit.

The term “candidate application statement” refers to one or more machine-generated text sequences that can be used, directly or after selection or modification, as part of application content to be submitted or stored.

The term “structured data” refers to data organized according to a defined schema, including one or more fields or attributes with specified types, enabling systematic parsing, validation, and query operations by a computer system.

The term “data structure” refers to an arrangement of data elements in memory or storage, such as an object, record, array, or document, designed to support specific access and processing operations.

The term “application processing device” refers to a computing component or system that receives application content and performs processing such as validation, approval, accounting, or further workflow actions.

The term “server” refers to a computing device or system configured to provide one or more services or functions over a network to one or more other devices, including processing, storage, or communication functions.

In one embodiment, a server, a terminal, and a user cooperate to implement the claimed system. The server includes at least one processor, a main memory, a non-volatile storage device, and a network interface. The terminal includes at least one processor, a memory, a local storage device, a display unit, an input unit, and one or more input devices such as a camera, a scanner, and a microphone. The user operates the terminal to capture imaged proof documents and to provide voice information and facial expression information. The server executes a software stack including an operating system, an image processing module, an optical character recognition module, a text parsing module, a database management module, and a generative artificial intelligence module interface. In one example, the server executes a general-purpose server operating system, and the image processing module uses image processing libraries of the same kind as those provided by general-purpose image processing software (for example, software comparable to Adobe Photoshop or GIMP). The optical character recognition module may employ an OCR engine of the same kind as open-source OCR engines (for example, engines similar to Tesseract OCR). The database management module may interact with a relational database management system of the same kind as known systems such as MySQL-type systems or PostgreSQL-type systems. The generative artificial intelligence module interface communicates with a generative AI model provided either locally or by an external AI service.

The terminal executes a terminal operating system and provides a user interface application. The terminal controls a camera to capture an imaged proof document. In one example, the user uses a smartphone camera to capture an image of a paper receipt placed on a flat surface under controlled lighting conditions. The terminal stores the captured image as electronic data in a designated storage region such as a specific folder reserved for proof documents. By standardizing the acquisition conditions and storage location, the terminal reduces variability in image input and minimizes random input/output access patterns.

The terminal performs preliminary preprocessing of the captured image data before transmission to the server. The terminal uses image processing libraries comparable to OpenCV to convert the image to grayscale, adjust resolution, and perform initial cropping. The terminal may reduce the image size to a standardized resolution while preserving character legibility. This downsampling reduces the amount of image data transmitted to the server, thereby reducing network bandwidth and lowering latency for subsequent processing. The server receives the preprocessed image data from the terminal through the network interface. The server stores the image data in a specific storage region of a storage device, such as a directory reserved for proof document images, and maintains an index associating each stored image with a unique identifier. The server uses this identifier as a primary key in a database table, thereby enabling efficient joining of image records with corresponding structured text records.

The server further performs advanced preprocessing on the stored image data. The server applies normalization of image features to stabilize image size, aspect ratio, and intensity distribution. The server computes a histogram of pixel intensities and applies contrast-limited adaptive histogram equalization to correct tone variations caused by uneven lighting. The server performs noise reduction processing by applying non-linear filters, such as median filtering, to suppress isolated noise pixels while preserving edges corresponding to character strokes. The server executes skew correction processing by detecting dominant text line orientations using line detection algorithms and rotating the image so that the lines align horizontally within a tolerance range.

By applying this deterministic sequence of preprocessing operations, the server reduces the variability in input images presented to the OCR engine. This results in reduced misrecognition rates, fewer character segmentation errors, and a lower need for post-recognition correction. Consequently, the OCR engine is invoked fewer times per document, and the processor performs fewer redundant cycles, improving overall computational efficiency.

The server executes optical character recognition processing on the preprocessed image data using an OCR module that implements a character classification model. The OCR module segments the preprocessed image into text lines, words, and individual character regions. The module then converts each character region into a feature vector representing stroke patterns and intensity distributions. A classifier, such as a convolutional neural network trained to map feature vectors to character labels, produces candidate character sequences. The module outputs character string information in a machine-readable text encoding and may also output auxiliary information such as character confidence scores and bounding box coordinates.

The server then executes a text parsing module to transform the character string information into structured item information. The server uses rule-based expression processing and statistical analysis processing. For example, the server applies regular expression patterns to detect date formats, monetary amounts, and entity names. The server may also apply a probabilistic sequence model to select the most likely segmentation of lines into fields based on contextual cues. By performing this combination of rule-based and statistical processing, the server reduces the need for manual field entry and achieves higher consistency than human operators, particularly for large volumes of documents.

The server assigns index information to the extracted item information. The server creates database records containing fields such as date, amount, entity name, expense category, and a reference to the associated image identifier. The database management module creates indexes on one or more of these fields to optimize query performance. This structured and indexed storage format reduces the number of full table scans required for typical queries and decreases database response time. The result is an improvement in data management performance at the level of the underlying computer system, not merely at the level of business workflow.

The user provides voice information and facial expression information through the terminal. The terminal uses a microphone to capture audio signals corresponding to the user's speech. The terminal digitizes the audio signals and performs feature extraction, such as computing mel-frequency cepstral coefficients or other spectral features. The terminal uses a camera to capture images or video of the user's face during interaction and computes facial landmarks and expressions using a facial analysis library. The terminal transmits the extracted feature information, rather than raw audio and video streams, to the server. This reduces the volume of data transmitted and thus reduces network load.

The server receives the feature information and provides it to a generative artificial intelligence model. In one embodiment, the generative AI model is implemented as a neural network architecture comprising an encoder and a decoder. The encoder includes multiple layers of a recurrent neural network or transformer blocks that receive the feature information as input and produce a latent representation of the emotional state. The model is trained using supervised learning on a dataset of labeled multimodal inputs, where emotional state labels are associated with combinations of voice and facial expression features. During training, the model minimizes an error function such as cross-entropy between predicted emotional state distributions and ground-truth labels by updating weight parameters via gradient-based optimization.

The server uses the trained model to estimate an emotional state for the current feature information. The server converts the latent representation and the predicted emotional state into a machine-usable form, such as a discrete label or a continuous vector. The server then generates adjustment information for application content by mapping the emotional state and the extracted item information to content parameters, such as tone of wording, level of detail, and selection of default values.

In order to instruct the generative AI model to produce machine-actionable outputs, the server generates a prompt sentence based on system state. The server constructs a prompt sentence that includes explicit instructions regarding both emotional state estimation and application content adjustment. For example, the server may generate a prompt sentence such as:

“Analyze the following emotional state features and adjust the expense application text to be concise and neutral while preserving all factual fields: date, amount, entity name, and expense category.”

In another example, the user may directly provide a prompt sentence through the terminal, such as: “Explain how this system digitizes a taxi receipt and stores it as structured data in the database, step by step.”

or

“Generate Python-like sample code that uploads a preprocessed receipt image to the server and calls the OCR and database APIs.”

The server provides such prompt sentences to the generative AI model. The generative AI model, implemented as a decoder network, generates output text that follows the specified constraints. Internally, the model uses attention mechanisms and its learned parameters to determine which fields to emphasize and how to phrase the content. The server post-processes the generated text to extract a generation policy or a candidate application statement. For example, the server may identify suggested field defaults, structure of the written explanation, or a template for how to phrase a reimbursement request.

By integrating prompt sentence generation with the system's internal state, the server uses the generative AI model in a non-conventional, deterministic manner. Instead of allowing arbitrary free-form conversation, the server constrains the model's tasks to produce outputs that can be parsed and directly used to update structured application content. This design reduces ambiguity and lowers the computational cost of human review and correction.

The server integrates the structured item information, the preprocessed electronic data, the adjustment information, and any candidate application statement into structured data. The server creates a data structure, such as a record or object, that contains pointers to image storage locations, normalized field values, emotional state indicators, and AI-generated text fragments. This integrated data structure is transmitted to an external application processing device. The application processing device may be a financial system, an approval workflow engine, or another server that processes application content.

Because the server maintains a consistent schema and uses structured data, downstream systems can process the records without re-parsing free-form text. This avoids repeated computation and reduces the likelihood of downstream parsing errors. Overall, the combination of image preprocessing, OCR optimization, structured field extraction, multimodal emotional state estimation, and prompt-driven generative AI guidance produces technical effects such as increased recognition accuracy, reduced processing latency, improved database performance, and reduced network and storage overhead.

In another embodiment, the server executes all preprocessing steps, while the terminal primarily captures raw images and audio/video streams. This embodiment may be suitable when the server has significantly greater computational resources. In yet another embodiment, the generative AI model is deployed locally on the server using hardware acceleration such as a graphics processing unit. This allows the server to perform low-latency inference, which is advantageous when many users simultaneously submit proof documents. In a further alternative embodiment, the text parsing module uses a hybrid approach combining rule-based processing with a learned sequence labeling model. The model assigns labels such as “DATE,” “AMOUNT,” “ENTITY,” and “CATEGORY” to tokens in the OCR output. By integrating statistical learning with deterministic rules, the server reduces the impact of OCR noise and improves robustness to unfamiliar receipt formats. This hybrid approach results in fewer misclassifications and lower error propagation into subsequent application content generation, thereby improving the reliability of the overall computer system.

In all embodiments, the system improves computer technology itself by reducing unnecessary reprocessing of images, by enforcing structured and indexed data storage, by using multimodal features to guide application content generation in a manner that decreases manual edits, and by constraining generative AI outputs via system-generated prompt sentences that are designed to be machine-actionable. These design choices lead to faster processing of large numbers of proof documents, higher accuracy of extracted data, more efficient use of storage and communication resources, and improved stability and scalability of the underlying computer infrastructure.

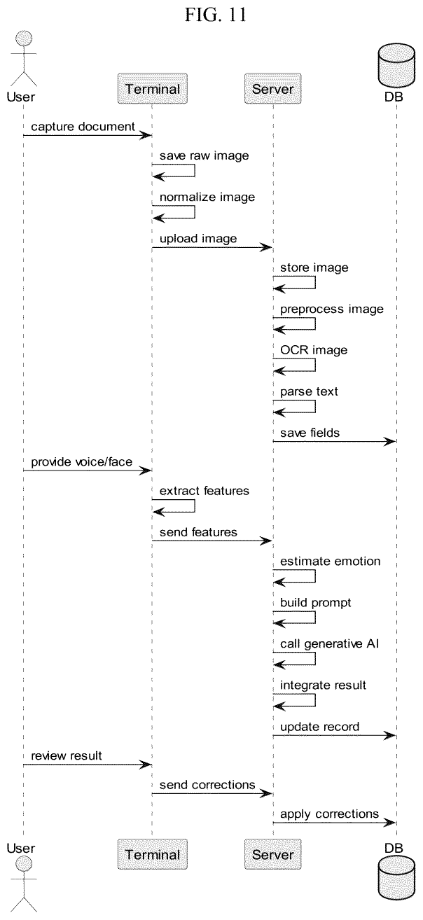

The following describes the processing flow using FIG. 11.
Step 1:

The user prepares one or more paper proof documents and places them on a flat, well-lit surface so that characters are clearly visible.

The user launches a camera application on the terminal and positions the camera such that the entire document is within the frame.

Input: a physical proof document.

The user captures a high-resolution image of the document and optionally re-takes the image until the characters are in focus and the document is not skewed.

Output: raw image data of the proof document stored temporarily in the terminal memory.
Step 2:

The terminal receives the raw image data from the camera component and converts the image into a standard digital format such as JPEG or PNG.

Input: raw image data from the camera sensor.

The terminal encodes the sensor data into a compressed image file, assigns a file name, and writes the file to a designated local storage region such as a “ProofDocuments” folder on an internal storage device.

Output: an image file stored in a predetermined storage region of the terminal.
Step 3:

The terminal performs preliminary image normalization to stabilize image size and orientation before transmission.

Input: the stored image file in the predetermined folder.

The terminal loads the image using an image processing library, converts the image to grayscale, resizes the image to a standard resolution, and performs an initial crop around the document edges detected by edge detection processing.

By applying these data transformations, the terminal reduces image variability and total data size, which improves subsequent recognition and reduces transmission load.

Output: a preliminarily normalized image file saved as a new file on the terminal.
Step 4:

The terminal transmits the preliminarily normalized image file to the server via a network connection.

Input: the normalized image file and associated metadata such as timestamp and terminal identifier.

The terminal constructs a request message, attaches the image file as binary payload, and sends the request to a server endpoint using a network protocol such as HTTPS.

Output: a network message containing the image file delivered to the server.
Step 5:

The server receives the network message and stores the attached image file in a server-side storage region.

Input: the network message with the normalized image file and metadata.

The server parses the request, validates file format and size, assigns a unique identifier to the document, and writes the image to a directory reserved for proof documents, recording the file path and identifier in a server-side index.

Output: a stored image file on the server and a corresponding record in an internal index structure.
Step 6:

The server applies advanced preprocessing to the stored image to optimize it for optical character recognition.

Input: the stored image file retrieved from the server storage path.

The server loads the image, computes a histogram of pixel intensities, performs contrast enhancement, applies noise reduction filters, executes skew detection by finding dominant text line angles, and rotates the image to align text horizontally.

By performing these data transformations, the server generates an image with improved character visibility and reduced noise, thereby lowering the probability of recognition errors in later stages.

Output: a fully preprocessed image file stored as a new version associated with the same unique identifier.
Step 7:

The server executes optical character recognition on the fully preprocessed image file.

Input: the preprocessed image file associated with the document identifier.

The server passes the image to an OCR engine, which segments text regions, detects individual character regions, and converts each region into feature vectors representing stroke and intensity patterns, then maps these vectors to character codes using a trained classifier.

The server aggregates the recognized characters into lines and text blocks and encodes the resulting character strings in a standard text encoding.

Output: raw character string information corresponding to the contents of the proof document, optionally with confidence scores and positional information.
Step 8:

The server parses the raw character string information to extract structured item information.

Input: recognized character strings and optional positional metadata from the OCR engine.

The server applies rule-based expressions and statistical parsing algorithms to identify date patterns, monetary amounts, entity names, and relevant descriptive phrases, and then converts these strings into normalized formats, such as ISO-formatted dates and numerical amounts. By performing this data processing, the server transforms unstructured text into machine-usable fields.

Output: structured item information including at least date information, amount information, entity name information, and candidate expense category information associated with the document identifier.
Step 9:

The server assigns index information to the structured item information and stores it in a database.

Input: structured item fields and the document identifier.

The server constructs a database record with columns for key fields, stores the normalized values, and creates or updates indexes on those columns so that future database queries can directly seek relevant records without full-table scans.

This data operation improves query performance and reduces processing time for retrieving document records.

Output: a persistent database record containing indexed item information linked to the stored image.
Step 10:

The user provides voice information and facial expression information via the terminal during or after document submission.

Input: a request to record emotional context from the user.

The user speaks into a microphone and looks at the terminal camera while interacting with the user interface, for example while confirming extracted fields.

The terminal captures audio and video data streams and converts them into digital signals for further analysis.

Output: raw audio data and raw image or video data representing the user's speech and facial expressions stored temporarily on the terminal.
Step 11:

The terminal extracts feature information from the captured audio and facial data.

Input: raw audio signals and raw image or video frames of the user's face.

The terminal computes spectral features such as mel-frequency cepstral coefficients from the audio, detects facial landmarks and expression vectors from the image frames, and aggregates these into a compact feature representation.

By performing this feature extraction, the terminal reduces the data volume and isolates characteristics relevant to emotional state estimation.

Output: feature information describing the user's voice and facial expressions, ready for transmission to the server.
Step 12:

The terminal transmits the feature information to the server for emotional state estimation.

Input: the extracted multimodal feature vectors and a reference to the related document identifier.

The terminal packages the feature information in a structured message and sends it to the server over the network using a secure protocol.

Output: a feature information payload delivered to the server and associated with the corresponding document record.
Step 13:

The server estimates an emotional state based on the received feature information using a generative AI model.

Input: the multimodal feature vectors and any associated contextual metadata.

The server feeds the feature vectors into an encoder component of a trained neural network that transforms them into a latent representation; the network then outputs probability values over predefined emotional categories or a continuous emotional vector.

The server interprets the output using predefined thresholds or similarity metrics to determine a representative emotional state label or score.

Output: an estimated emotional state associated with the user and the document identifier.
Step 14:

The server generates adjustment information for application content using the estimated emotional state and the structured item information.

Input: the estimated emotional state label and the stored item information fields.

The server applies mapping rules and parameterized logic to determine how to adjust the application content, such as selecting a suitable tone, level of detail, and suggested defaults for optional fields, and encodes these decisions as adjustment parameters or directives.

This data computation creates machine-readable instructions for tailoring the content while preserving factual accuracy, thereby reducing the need for manual rewriting.

Output: adjustment information defining modifications and content-generation parameters for the application record.
Step 15:

The server generates a prompt sentence to control the behavior of the generative AI model for content generation or refinement.

Input: the item information, the adjustment information, and the estimated emotional state.

The server constructs a textual instruction including explicit references to required fields and desired style, for example: “Generate a concise and neutral expense application text that includes the following fields: date, amount, entity name, and expense category, taking into account that the user is in a frustrated state and minimizing additional questions.”

By embedding structured constraints in the prompt sentence, the server ensures that the generative AI model produces output that is directly usable by downstream modules.

Output: a system-generated prompt sentence ready to be provided to the generative AI model.
Step 16:

The server invokes the generative AI model with the generated prompt sentence.

Input: the prompt sentence and, optionally, context tokens representing the structured fields and emotional state.

The server sends the prompt to the model, receives token-by-token generated output, and monitors generation boundaries according to predefined limits such as maximum length and termination tokens.

The model's output is a text sequence that follows the specified constraints, such as a candidate application statement or a description of an adjustment policy.

Output: generated text representing a candidate application statement and/or a generation policy derived from the prompt.
Step 17:

The server parses and integrates the generative AI output with the existing structured data.

Input: the generated text and the current structured record containing item information and adjustment information.

The server analyzes the generated text to extract key segments, such as a finalized application statement, and associates these segments with designated fields in the record, while retaining references to the original item values for traceability.

This integration converts free-form generated text into structured, machine-actionable content associated with the document identifier.

Output: an updated structured data record including the finalized application text and related metadata.
Step 18:

The server stores the updated structured data record in the database and prepares it for external application processing.

Input: the integrated record containing item information, emotional state, adjustment information, and AI-generated application content.

The server updates the corresponding database entry, ensuring that indexes referencing key fields remain valid, and flags the record as ready for submission to an external application processing device.

By maintaining a unified, indexed record, the server enables efficient retrieval and minimizes redundant recomputation in downstream systems.

Output: a finalized, searchable database record linked to the proof document image and associated with an application processing status.
Step 19:

The terminal presents a summary of the processed record to the user for optional review.

Input: the finalized structured record retrieved from the server, including key fields and the AI-generated application statement.

The terminal displays the fields and text in a user interface, allowing the user to inspect values and, if necessary, input corrections for specific fields or wording.

If the user edits values, the terminal sends correction messages back to the server so that the server can update the corresponding database record and maintain data consistency.

Output: user-confirmed or user-adjusted application content synchronized between the terminal and the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional expense processing systems that convert paper-based transaction evidence, such as receipts, into digital expense records often rely on fragmented processing pipelines and manual user intervention. In many existing implementations, image capture, optical character recognition (OCR), data storage, and expense registration are performed as loosely coupled steps using heterogeneous components that are not systematically integrated. This leads to multiple technical problems in computer operation, including increased processing latency, high error rates in character recognition, inefficient use of storage and communication resources, and the need for repeated user input corrections.

In particular, when receipt images are processed without appropriate image pre-processing, OCR engines tend to misrecognize characters due to noise, skew, poor contrast, or geometric distortion. This degrades recognition accuracy and forces the system to re-run OCR or requires a user to re-enter data, thereby increasing processor load, memory access, and network traffic. Furthermore, when structured data extracted from receipts is stored in external storage services without standardized metadata such as user identifiers, processing time information, and expense category information, subsequent server-side processes must perform additional searches and heuristic classification. This results in inefficient database operations, redundant network access, and increased computation for mapping records to users and categories.

Another technical challenge arises when users interact with expense processing interfaces under varying emotional states, such as frustration or confusion caused by recognition errors or complex forms. Conventional systems generally present static user interfaces and do not adapt content or presentation based on a user's emotional state. As a result, users may abandon correction or verification tasks, causing incomplete data and forcing background processes to handle inconsistent records, which in turn increases error-handling logic and system complexity.

Therefore, there is a need for a computer-implemented technique that improves the end-to-end pipeline from acquisition of image information of transaction evidence, through OCR and pre-processing, to structured data generation, external storage integration, and expense registration, while dynamically adjusting the presentation and handling of settlement information using an artificial intelligence model. Such a technique should enhance character recognition accuracy, reduce redundant processing, improve the efficiency of data classification and storage access, and adaptively manage user interaction based on estimated emotional state, thereby improving the overall technical performance and reliability of the expense processing system.

The specific processing by the specific processing unit 290 of the data processing device 12 in Application Example 1 is realized by the following means.

The present invention provides a server comprising a processor configured to acquire image information by optically reading transaction evidence recorded on a physical medium, convert the transaction evidence into electric signals, and store the image information in a predetermined storage region of an information storage device; execute image pre-processing, including gradation conversion processing, noise reduction processing, and geometric correction processing, on the image information; apply an optical character recognition process to the pre-processed image information by using character recognition software, extract character information, and generate structured data including a transaction date, a transaction amount, and transaction counterpart identification information from the character information; transmit the structured data to an external storage service via a communication line and cause the external storage service to store the structured data together with attribute information including a user identifier, processing time information, and expense category information; acquire the structured data from the external storage service, input the structured data into an information processing function of a business processing apparatus, convert the structured data into an internal data format for expense processing, automatically classify and register the converted data as settlement information in an expense processing function based on the attribute information; acquire voice information and expression information of a user from an input device, analyze the voice information and the expression information, estimate an emotional state of the user by using a generative artificial intelligence model, adjust content or presentation of the settlement information based on the estimated emotional state; and generate a data structure in which the image information of the transaction evidence and the structured data are associated with each other and transmit the data structure to an application processing function. This enables improvement of the technical performance of the expense processing pipeline by reducing OCR errors through pre-processing, optimizing data flow between local storage, external storage, and internal business processing functions, decreasing redundant computation for user and category association through standardized attribute information, and dynamically adapting user interaction based on an estimated emotional state, thereby enhancing processing efficiency, reliability, and usability of the computer-implemented expense processing system.

The term “transaction evidence” refers to information-bearing media such as receipts, invoices, tickets, or similar documents that record details of a commercial or financial transaction, including at least a transaction date, a transaction amount, and identification of a transaction counterpart.

The term “physical medium” refers to a tangible substrate, such as paper or a card, on which transaction evidence is recorded in human-readable form, for example by printing or handwriting.

The term “image information” refers to digital data representing a visual image of transaction evidence, the data including pixel values obtained by optically capturing the physical medium using an imaging device.

The term “information storage device” refers to a hardware component or system that stores digital data, such as a semiconductor memory, a magnetic storage device, an optical storage device, or a combination thereof.

The term “storage region” refers to a logically or physically identifiable area within an information storage device that is allocated for storing particular digital data, such as a file, a record, or an image.

The term “image pre-processing” refers to a series of computational operations applied to image information prior to optical character recognition, the operations including at least gradation conversion processing, noise reduction processing, and geometric correction processing.

The term “gradation conversion processing” refers to a transformation applied to image information to adjust or convert color or intensity values, such as converting from color to grayscale or modifying contrast, in order to enhance visibility of characters.

The term “noise reduction processing” refers to a computational operation that suppresses or removes unwanted variations in pixel values, such as speckles, artifacts, or random fluctuations, in order to improve the clarity of characters contained in the image information.

The term “geometric correction processing” refers to a computational operation that compensates for distortions in image information, such as rotation, skew, perspective distortion, or misalignment, so that characters and lines in the image are aligned in a manner suitable for recognition.

The term “character recognition software” refers to a software component that implements optical character recognition, the component being configured to analyze pixel patterns in image information, segment characters, and output corresponding character codes or textual data.

The term “character information” refers to textual data obtained by applying optical character recognition to image information, the textual data representing characters, numerals, or symbols present on the transaction evidence.

The term “structured data” refers to digital data in which elements such as transaction date, transaction amount, and transaction counterpart identification information are explicitly represented as fields or attributes in a machine-readable format, such as a record, a table entry, or a structured document.

The term “transaction date” refers to a data field within structured data that represents a calendar date on which a corresponding transaction recorded in the transaction evidence occurred.

The term “transaction amount” refers to a data field within structured data that represents a monetary value associated with a transaction recorded in the transaction evidence, optionally including a currency code or unit.

The term “transaction counterpart identification information” refers to a data field within structured data that identifies a party involved in a transaction, such as a merchant name, a service provider name, or another entity designation.

The term “external storage service” refers to a network-accessible data storage system provided over a communication network, the system being configured to store, manage, and provide access to digital data independently of a local device.

The term “communication line” refers to a wired or wireless communication path, such as a local area network, a wide area network, or the Internet, that enables transmission of digital data between the server and an external storage service or other devices.

The term “business processing apparatus” refers to a computing system configured to perform business-related data processing operations, such as accounting, expense management, approval workflows, or other administrative processing.

The term “information processing function” refers to a software-implemented function executed by a processor that processes input data, performs transformations, calculations, or validations, and outputs processed data for subsequent use.

The term “internal data format for expense processing” refers to a data representation scheme used within an expense processing function, the scheme defining fields, types, and relationships suitable for storing, calculating, and managing expense-related records.

The term “settlement information” refers to digital data representing expense items or financial obligations derived from transaction evidence, the data being used for reimbursement, accounting, or financial settlement purposes.

The term “expense processing function” refers to a software-implemented function that manages expense-related data, including registration, classification, aggregation, approval, and settlement of expenses.

The term “user terminal” refers to an electronic device operated by a user, such as a smartphone, tablet, personal computer, or similar device, that is capable of displaying information and sending input to a server via a communication network.

The term “input device” refers to a hardware component that acquires user-related data, such as a microphone for capturing voice information, a camera for capturing facial expressions, or a sensor array for detecting user behavior.

The term “voice information” refers to digital data representing sound signals produced by a user, typically obtained from a microphone and processed as audio data for subsequent analysis.

The term “expression information” refers to digital data representing facial or bodily expressions of a user, typically obtained from an imaging device and used to infer emotional or affective states.

The term “generative artificial intelligence model” refers to a machine-learned computational model that can generate or transform data, such as text or features, in response to input data, and that is trained to infer, estimate, or simulate patterns including user emotional states based on multimodal inputs.

The term “emotional state” refers to an inferred internal affective condition of a user, such as satisfaction, frustration, confusion, or confidence, estimated by analyzing voice information and expression information using a generative artificial intelligence model.

The term “content or presentation of the settlement information” refers to at least one of the specific data items included in the settlement information and the manner in which the settlement information is displayed or arranged on a user interface.

The term “data structure” refers to an organized digital representation in which related data elements, such as image information and structured data, are stored, indexed, or linked together in a form suitable for computer processing.

The term “application processing function” refers to a software-implemented function that processes application data, such as reimbursement requests, approval requests, or similar application records, using associated image information and structured data.

The term “attribute information” refers to supplemental data associated with structured data, including at least a user identifier, processing time information, and expense category information, which is used to manage, classify, or retrieve expense records.

The term “user identifier” refers to data that uniquely or distinctively identifies a particular user within a system, such as a user ID, account ID, or similar identifier.

The term “processing time information” refers to data representing a time or date at which a particular processing step, such as OCR execution or data transmission, was performed by the system.

The term “expense category information” refers to data indicating a classification of an expense, such as a category name, code, or label, used for grouping or analyzing expense items.

The term “automatically classify” refers to performing a classification operation by a processor without requiring manual selection by a user, based on predefined rules, attribute information, or learned models.

In one embodiment, a server coordinates an end-to-end receipt processing system that integrates a terminal, an external storage service, and one or more business processing apparatuses. The server executes a program stored in a non-transitory computer-readable storage medium. The program is configured to control capture of image information of transaction evidence, execution of optical character recognition (OCR) with dedicated image pre-processing, management of structured data and metadata, and adaptive presentation of settlement information based on an emotional state estimated by a generative AI model. A terminal is implemented, for example, as a smartphone, tablet, or other portable information terminal. The terminal includes an imaging device such as a built-in camera module, a microphone, a display, local storage (e.g., internal flash memory or a solid-state drive), a wireless communication interface, and a processor. The terminal executes an application that interacts with the server through a communication network. The terminal uses an operating system such as a mobile operating system and employs a camera control framework such as a generic camera API (e.g., CameraX-like interface or AVFoundation-like interface). The terminal uses an OCR engine such as a Tesseract-type library and optionally uses an image processing framework such as an OpenCV-type library for pre-processing.

The server is implemented, for example, on general-purpose computing hardware including one or more processors (e.g., multi-core CPUs), volatile memory (RAM), non-volatile storage (e.g., SSD), and a network interface. The server executes a server-side application on top of an operating system and an application framework such as a web framework (e.g., a Python-based framework, a Java-based framework, or a JavaScript-based framework). The server accesses an external database management system, such as a relational database, to store structured data, settlement information, and learned parameters of a generative AI model. The server communicates with an external storage service, such as a generic cloud-based object storage system, using a standard network protocol such as HTTPS and an application programming interface (API) provided by the external storage service.

The server uses an external storage service to persist structured data and associated metadata. For instance, the server or terminal uploads a structured data file representing extracted fields from a receipt to the external storage service. The structured data file may be represented as a structured record format such as a key-value format internally, though the external file representation may be any machine-readable format. The server associates attribute information such as a user identifier, a processing timestamp, and an expense category with each record. The server thus maintains, in combination with the external storage service, a logically partitioned storage region dedicated to receipt-derived records, which allows efficient retrieval and classification by the server.

The server enhances character recognition accuracy and computational efficiency by controlling a specific image pre-processing pipeline. The terminal or the server performs gradation conversion, noise reduction, and geometric correction on image information before OCR. In one embodiment, the terminal converts a color image to a grayscale image, applies adaptive thresholding, and performs deskew and perspective correction using a sequence of matrix transformations defined by estimated corner points of the receipt area. This processing reduces input variability seen by the OCR engine, thereby decreasing recognition errors. The server thus reduces the number of times OCR must be re-executed and reduces the frequency of manual correction. As a result, the server improves overall system throughput and reduces processor utilization associated with repeated OCR operations.

The server constructs structured data by parsing OCR text into distinct fields. The server or terminal applies rule-based parsing that uses regular expressions, pattern templates, and tokenization. For example, the server defines a rule set that identifies date strings using fixed date patterns, identifies monetary values using digit sequences combined with currency markers, and identifies merchant names using positional and lexical cues. The server normalizes extracted values into an internal data format for expense processing, such as standardized date strings and numerical amounts. This structured data is stored in a database with a schema that defines tables for receipts, users, merchants, and expense categories. The server thereby improves data management by enforcing consistent data types and relational constraints at the database level, which reduces query complexity and improves indexing performance.

The server configures a generative AI model to estimate a user's emotional state and to adjust content or presentation of settlement information. In one embodiment, the server implements the generative AI model as a multi-modal neural network including the following components:
(1) A voice feature extractor that processes an audio waveform captured by the microphone of the terminal. The server applies short-time Fourier transform (STFT) to the waveform to obtain a spectrogram, then uses a convolutional neural network (CNN) to extract time-frequency features such as pitch contour, energy patterns, and formant distributions.
(2) An expression feature extractor that processes facial image frames captured by the camera of the terminal. The server applies a face detection algorithm to identify a face region, then uses a CNN-based encoder (e.g., a residual network-like architecture) to generate high-dimensional embeddings representing facial action units such as eyebrow movement, mouth shape, and eye openness.
(3) A temporal modeling module that integrates the voice and expression feature sequences across time. The server uses a recurrent neural network (RNN) such as a long short-term memory (LSTM) network or a gated recurrent unit (GRU) network, or alternatively a transformer-type encoder, to aggregate feature sequences into a compact representation of the user's current emotional context.
(4) A generative decoding module that, given the emotional context representation and structured settlement information, generates adjustment scores and presentation parameters. The server uses a feedforward neural network or transformer-style decoder to output continuous-valued parameters representing, for example, the level of detail to show, the prioritization of items that require user attention, or the necessity of showing confirmation hints. The same module may output classification probabilities over predefined emotional categories (such as “confused,” “confident,” “frustrated”) and continuous attributes such as “cognitive load.”

The server trains the generative AI model using a training dataset that includes pairs of multi-modal input (voice and expression sequences) and target outputs (emotional labels and recommended interface adjustment parameters). The server uses a supervised learning procedure where a loss function is defined as a weighted sum of a cross-entropy loss for emotional category classification and a mean squared error loss for the adjustment parameters. The server updates the model weights using gradient-based optimization, such as stochastic gradient descent with momentum or an adaptive optimizer. Data augmentation is optionally applied to audio data (e.g., time stretching, pitch shifting, noise injection) and to facial image data (e.g., small rotations, scaling, brightness changes) to improve robustness. By explicitly modeling the mapping from multi-modal features to interface adjustment parameters, the server enables the generative AI model to produce interface control signals that are not based on simple rule-of-thumb thresholds but on learned correlations that a human operator would not feasibly compute in real time.

The server uses the outputs of the generative AI model to alter specific technical parameters in the user interface presented on the terminal. For example, if the model indicates a high probability of user confusion, the server increases the density of inline explanations, expands the display of key fields (such as transaction amount and date), and reduces the number of visible advanced options to decrease cognitive load. Conversely, if the model indicates a confident user state, the server collapses detailed hints, groups multiple similar receipts into a summarized view, and displays more advanced options in a single screen. These adjustments change the amount of data transmitted, the layout computation on the terminal, and the number of interaction steps required. As a result, the server reduces network round trips, improves cache hit rates on the terminal, and decreases the overall error rate in user confirmation operations. This is not a mere automation of human decision-making; the system uses a learned mapping from high-dimensional sensor data to interface control parameters, thereby improving the efficiency of the underlying data processing and interaction pipeline in a way that would not be achievable by simple static rule-based interfaces.

The server improves communication efficiency and data management by attaching attribute information to structured data before sending it to the external storage service. The server sets fields such as a user identifier, a processing timestamp, and an expense category identifier at the time of upload. Because these attributes are embedded in the stored records, the server can later retrieve and classify records with a single database query or external storage API call using indexed fields. This reduces the need for expensive text searches or heuristic classification. The server therefore reduces the number of network calls and the amount of data transmitted, providing a concrete improvement in communication performance over systems that rely on unstructured storage.

In another embodiment, the server uses alternative OCR engines or hardware accelerators. For example, the server configures the terminal to execute OCR on a dedicated hardware accelerator such as a neural network processing unit (NPU), or the server itself performs OCR on a GPU-accelerated node. The pre-processing pipeline remains similar, but specific operators such as convolutions for noise reduction and geometric transformations can be executed using parallel hardware, resulting in further reductions in processing latency. The server thereby offloads computationally heavy tasks to specialized hardware in a controlled manner, providing improved processing speed and energy efficiency.

In a further embodiment, the server modifies the structure of the database for settlement information to optimize for receipt-based queries. The server creates composite indices over (user identifier, transaction date, expense category) and stores structured data in normalized tables with foreign keys to user and category tables. Additionally, the server maintains a denormalized summary table for frequently accessed aggregates (such as total expenses per day or per category). The server updates the summary table incrementally when new structured data is registered. This design reduces the number of join operations and disk I/O required at query time, which directly improves response time and scalability of the overall system.

The server integrates the generative AI model not merely as a high-level classifier but as a module that modifies low-level parameters of processing modules. For example, when the model predicts a frustrated emotional state, the server may increase the threshold for OCR re-execution, reducing re-processing of marginally low-quality images; simultaneously, the server may enable an additional confirmation step that highlights only high-risk fields rather than all fields. This combined policy, derived from learned parameters, reduces redundant computation while still minimizing errors in critical data fields. The server thereby achieves a technical effect of decreased processor load and improved accuracy in the most important fields, thereby optimizing resource allocation.

A user interacts with the system via the terminal. The user positions the terminal to capture an image of a receipt, speaks comments or confirmations that are captured by the microphone, and reviews settlement information displayed on the screen. However, the user does not manually control the internal data processing sequence or the generative AI model. Instead, the server orchestrates data flows, including the transfer of image information, structured data, attribute information, and emotional-state-related signals. The server ensures that each computational step operates on well-defined data structures with explicit fields and formats, thereby enabling deterministic and reproducible improvement in the performance of the computer system as a whole.

In yet another embodiment, the server uses rule-based logic together with the generative AI model to determine how to rectify OCR errors. The server maintains a rule set that maps certain patterns of OCR uncertainty (e.g., low-confidence digits in the amount field) to specific rectification strategies, such as recapturing the image, requesting manual confirmation for only that field, or invoking a higher-precision OCR model. The generative AI model provides an estimate of the user's tolerance for additional steps based on emotional state. The server combines rule-based predictions with the emotional estimate to decide whether to invoke additional heavy processing. This hybrid approach allows the server to save computational resources when the user is already comfortable with approximate results, and to allocate more resources when the user is likely to demand high accuracy. This kind of adaptive resource management is technically distinct from simply automating manual data entry, because it dynamically changes algorithmic pathways and resource usage within the computer system based on learned behavioral and emotional patterns.

For illustration, a user may provide a prompt sentence to a generative AI model for development or configuration assistance, such as:

“Explain step by step how a smartphone app can take a photo of a taxi receipt, extract the date, fare, and driver's name using an OCR engine, save the extracted data to a cloud storage service, and then send that data from a server to an expense settlement system so that expenses are recorded automatically.”

In another example, the user may use a prompt sentence such as:

“Generate example processing steps for a system where a terminal captures a receipt image, performs image pre-processing and OCR, uploads structured expense data with user identifiers and categories to an external storage service, and a server retrieves it, classifies it, and adjusts the user interface based on an emotional state estimated from voice and facial features.”

These prompt sentences are used during configuration or design of the system, but the deployed system itself performs the described operations automatically using the server-controlled processes and models.

In alternative embodiments, the server may implement different neural network architectures for the generative AI model, such as a purely transformer-based multi-modal encoder-decoder, or may use unsupervised pre-training on large-scale unlabeled voice and facial expression data followed by fine-tuning on labeled emotional and interface-adjustment data. The server may modify the loss function to include regularization terms that penalize rapid changes in interface parameters to avoid abrupt user experience changes. The server may adjust hyperparameters such as the number of layers, hidden dimensions, and learning rates to balance model accuracy and inference cost. These design choices directly influence computational load, memory footprint, and latency of the emotional-state estimation and, hence, affect the overall system performance.

By integrating these specific data structures, pre-processing pipelines, neural network architectures, and resource management strategies, the server provides an implementation that improves the functioning of a computer system itself. The system reduces OCR error rates through targeted image pre-processing, optimizes data storage and retrieval through structured metadata and tailored database schemas, reduces computational overhead through adaptive processing paths informed by a generative AI model, and decreases communication load by embedding attributes that allow efficient filtering. These improvements are achieved through concrete algorithmic and architectural features, rather than by implementing a generic business method, thereby providing a technical solution to technical problems in computer-based receipt and expense processing.

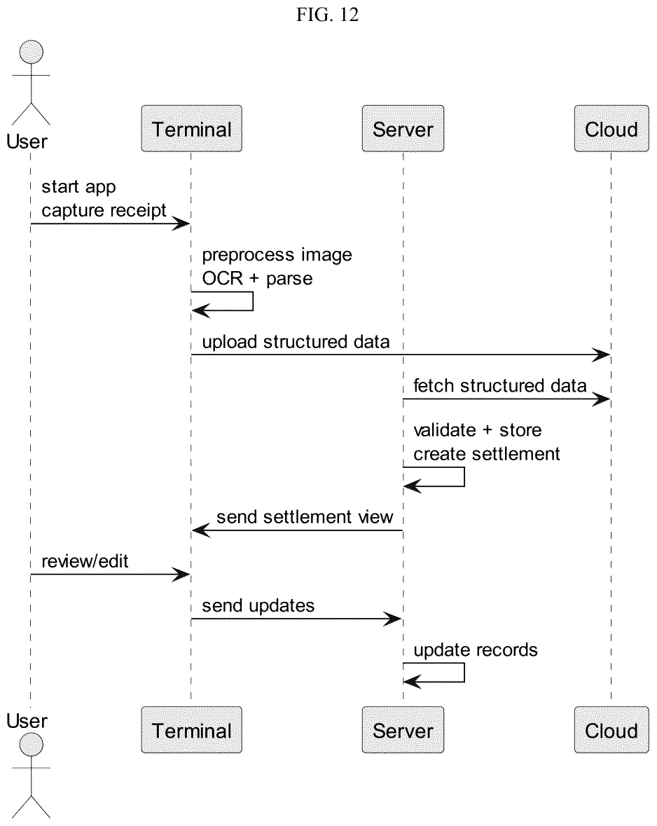

The following describes the processing flow using FIG. 12.
Step 1:

User operates the terminal to start a receipt processing application and to capture transaction evidence.

User launches the application, selects a capture function, and positions the terminal so that a physical receipt is fully visible in the camera preview.

Input: a physical receipt containing printed characters such as date, amount, and merchant information.

Terminal uses a camera API to control the imaging device, converts analog optical signals from the receipt into digital sensor data, and encodes the data into an image file (for example, JPEG).

Output: a digital receipt image stored in a local storage region of the terminal.
Step 2:

Terminal performs image pre-processing on the stored digital receipt image.

Terminal loads the image from local storage and applies gradation conversion, noise reduction, and geometric correction using an image processing library.

Input: the raw digital receipt image from Step 1.

Terminal converts the image to grayscale or an equivalent intensity representation, applies filtering to remove speckle noise and compression artifacts, and performs deskew and perspective correction by estimating and correcting rotation and distortion matrices.

Output: a pre-processed receipt image with enhanced contrast and alignment, stored as an updated image buffer or file.
Step 3:

Terminal executes optical character recognition on the pre-processed receipt image.

Terminal invokes OCR software, passes the pre-processed image as input, and requests text extraction over the entire image region.

Input: the pre-processed receipt image from Step 2.

Terminal applies character segmentation algorithms to identify text regions, lines, and individual characters, then applies pattern recognition models to map pixel patterns to character codes, aggregating recognized characters into strings.

Output: raw OCR text data representing the characters recognized from the receipt image.
Step 4:

Terminal generates structured data from the raw OCR text.

Terminal applies parsing logic, including regular expressions and rule-based mapping, to identify semantic fields.

Input: the raw OCR text from Step 3.

Terminal tokenizes the text, searches for patterns matching date formats, numeric sequences representing amounts, and strings likely representing merchant names, and normalizes these values into an internal schema with explicit fields such as transaction date, transaction amount, and transaction counterpart identification information.

Output: structured data representing the receipt content, stored as field-level records in memory within the terminal.
Step 5:

Terminal attaches attribute information to the structured data.

Terminal determines a user identifier, processing time, and initial expense category, and appends these as metadata fields.

Input: the structured data from Step 4 and user/account context stored on the terminal.

Terminal reads a user ID from a secure local store or session token, records a timestamp for the processing event, and assigns an expense category based on predefined mapping rules or user selection, and then writes these attributes into the structured data object.

Output: enriched structured data that includes both core receipt fields and attribute information.
Step 6:

Terminal transmits the enriched structured data to an external storage service.

Terminal initiates a network connection, authenticates with the external storage service, and uploads the structured data as a stored object.

Input: the enriched structured data from Step 5.

Terminal serializes the structured data into a machine-readable file, issues an API request over a secure channel, and waits for a response containing an object identifier or status code.

Output: a stored record in the external storage service and a confirmation response recorded on the terminal, including an identifier that references the stored structured data.
Step 7:

Server retrieves the structured data from the external storage service.

Server periodically or on demand queries the external storage service using stored credentials and filters for new or updated records.

Input: metadata index from the external storage service and identifiers for stored records.

Server issues list and download requests via an API, receives structured data files, and decodes them into internal memory objects.

Output: a collection of structured data records and associated attribute information loaded into the server's working memory.
Step 8:

Server validates and normalizes the structured data for expense processing.

Server checks each data field against defined constraints and converts formats to an internal expense schema.

Input: the structured data records from Step 7.

Server verifies that dates match permitted formats and ranges, confirms that numerical fields are correctly parsed and non-negative, checks that mandatory fields such as user identifier and merchant information are present, and converts values into canonical representations (for example, standardized date strings and currency-normalized amounts).

Output: validated and normalized expense records ready for insertion into an internal database.
Step 9:

Server stores the validated expense records in a business processing database and updates summary data.

Server inserts or updates records in normalized tables and maintains aggregate information.

Input: the validated and normalized expense records from Step 8.

Server executes database operations to store each receipt record in a receipt table linked by foreign keys to user, merchant, and category tables, and updates or recalculates summary entries such as totals per user and per category.

Output: persistent database entries representing settlement information and updated summary records.
Step 10:

Server constructs and registers settlement information in an expense processing function.

Server converts database records into internal settlement objects and registers them as expense items.

Input: database records stored in Step 9.

Server loads relevant records, maps them to in-memory structures expected by the expense processing engine, computes any derived values such as tax amounts or category subtotals, and registers each as a settlement item with status and linkage to the corresponding user.

Output: settlement information accessible to downstream expense processing modules.
Step 11:

Server acquires user voice information and expression information via the terminal.

Server requests the terminal to capture audio and facial images when the user reviews settlement information.

Input: user interaction events and capture commands sent from the server to the terminal.

Terminal records audio through a microphone and captures video frames or still images through the camera, encodes the data, and transmits it to the server.

Output: digital audio data and facial image data streams received by the server for emotional-state analysis.
Step 12:

Server computes multi-modal features from the voice information and expression information.

Server feeds the raw audio and image data to dedicated feature extraction modules.

Input: digital audio data and facial image data from Step 11.

Server converts audio to a sequence of spectral representations such as spectrograms, applies a convolutional feature extractor to obtain high-level audio embeddings, detects face regions in image data, and applies a convolutional encoder to generate facial expression embeddings, then aligns the temporal sequences of these embeddings.

Output: synchronized sequences of audio feature vectors and facial feature vectors representing user behavior over time.
Step 13:

Server estimates a user emotional state using a generative AI model.

Server inputs the multi-modal feature sequences and current interaction context into a trained neural network.

Input: audio and facial feature sequences from Step 12 and context information such as the type and count of visible settlement items.

Server processes the input via a temporal modeling layer (for example, a recurrent or transformer-based network) to produce an internal emotional context representation, and then applies one or more output layers to produce emotional category probabilities and continuous parameters indicating cognitive load or frustration level.

Output: an estimated emotional state, including discrete labels and numerical adjustment parameters.
Step 14:

Server adjusts content and presentation of settlement information based on the estimated emotional state.

Server modifies interface parameters and data selection rules before sending data to the terminal.

Input: settlement information from Step 10 and emotional-state parameters from Step 13.

Server applies a decision algorithm that, for high confusion indicators, increases the level of detail, expands critical fields, and suppresses advanced options, and for high confidence indicators, compresses detailed hints and groups entries for faster review, and encodes a presentation configuration specifying layout, field visibility, and interaction flow.

Output: an adjusted set of settlement information and a presentation configuration to be rendered by the terminal.
Step 15:

Server transmits the adjusted settlement information and presentation configuration to the terminal.

Server prepares a response message and sends it through the network interface.

Input: the adjusted settlement information and presentation configuration from Step 14.

Server serializes the data into a response payload, sends it over a secure communication channel to the terminal, and awaits acknowledgment.

Output: a received configuration and dataset on the terminal, enabling context-aware display of settlement information to the user.

Step 16:

User reviews and, if necessary, corrects settlement information on the terminal.

User inspects the displayed items, interacts with highlighted fields, and confirms or edits entries.

Input: the adjusted settlement view and interaction controls presented on the terminal based on Step 15.

Terminal captures user input such as taps and text edits, updates local representations of the corresponding records, and transmits corrected or confirmed data back to the server.

Output: user-validated settlement data, including any corrections to fields such as date, amount, or merchant.
Step 17:

Server updates stored settlement information and records interaction outcomes.

Server integrates user corrections and logs emotional and interaction metrics for further optimization.

Input: user-validated settlement data from Step 16 and previously stored database entries from Step 9 and Step 10.

Server applies updates to the relevant database records, logs statistics such as correction frequency per field and emotional-state patterns, and may adjust model training data or rule parameters for future sessions.

Output: finalized settlement records with improved accuracy and historical logs that support continuous improvement of processing accuracy and interaction efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional receipt management systems largely rely on manual entry and rigid database queries, which results in several technical problems in computer-based information processing. First, when receipt information is captured only as image data, a computing device must either store unstructured image files or perform ad hoc, application-specific parsing. This leads to inefficient memory usage, redundant storage of similar files, and high processing overhead each time a user requests an analysis, because the system needs to repeatedly process low-level image data or semi-structured text instead of reusing normalized structured data.

Second, traditional systems that apply optical character recognition (OCR) often produce raw text strings that are not properly normalized or associated with clearly defined attribute fields. As a result, the database layer cannot perform optimized indexing, aggregation, or filtering, and the query engine must handle ambiguous string comparisons and inconsistent formats. This causes increased CPU load, degraded query performance, and difficulty in scaling the system when the number of receipts and users grows.

Third, conventional systems typically provide only fixed-format query interfaces and pre-defined reports. When a user wishes to perform a flexible, natural-language query, the system either cannot support it at all or must employ additional application logic that operates separately from the core data management components. This separation leads to duplicated logic, complex state management between user interface and back-end, and inefficient translation between natural-language inquiry and database-level operations.

Fourth, although generative AI models can generate natural-language responses, naive integration of such models with receipt data creates further technical issues. If a generative AI model receives only the user's prompt sentence without well-structured, pre-aggregated receipt data, the model has to infer or simulate data, which risks hallucinations and inconsistent answers. Moreover, repeated invocation of the generative AI model for basic aggregation tasks (such as summing amounts) wastes computational resources, because operations that are more efficiently executed by database engines are offloaded to a neural network. This leads to unnecessary GPU or accelerator utilization and increased latency. Accordingly, there is a need for a computer-implemented technique that: (i) systematically converts receipt images into structured data that can be efficiently indexed and aggregated; (ii) normalizes and stores receipt attributes in a form optimized for machine processing and scalable querying; and (iii) tightly integrates a generative AI model with a structured information management region, such that the generative AI model operates on pre-filtered and pre-aggregated data, thereby improving accuracy, response time, and computational efficiency when responding to natural-language prompt sentences. The technical problem is therefore to improve the functioning of a computer system itself in handling receipt images, structured receipt data, and natural-language queries, rather than merely automating a manual business process.

The specific processing by the specific processing unit 290 of the data processing device 12 in Example 2 is realized by the following means.

The present invention provides a server comprising a processor and a memory storing instructions which, when executed by the processor, cause the server to receive transaction-related proof images from a terminal device via a communication network, to store the images in a storage region, to perform character recognition processing on the stored images to generate text information, to parse and normalize the text information into structured transaction attributes including at least date information, amount information, and entity information, to register the structured transaction attributes in an information management region as a plurality of attribute items, to receive from the terminal device a natural-language prompt sentence including inquiry content provided by a user, to determine query intent including at least target period information and aggregation condition information based on the prompt sentence, to execute aggregation processing and classification processing on the information management region according to the determined query intent to obtain numerical information and related structured information, to construct an input context comprising the prompt sentence and the obtained structured information, to supply the input context to a generative AI model executing on a computing resource, to cause the generative AI model to generate a natural-language response sentence based on the input context, and to transmit the response sentence to the terminal device for presentation. This enables the computer system to convert unstructured receipt images into normalized, attribute-based data suitable for efficient indexing and aggregation, to offload deterministic aggregation and filtering operations to optimized database and processing components, and to use the generative AI model primarily for natural-language generation conditioned on pre-verified structured information, thereby improving overall system performance, scalability, and response accuracy in handling user prompt sentences related to receipt data.

The term “processor” refers to a hardware information processing element, such as a central processing unit or other computing element, that executes instructions to perform operations including communication control, image processing, text processing, database operations, and interaction with a generative AI model.

The term “terminal device” refers to an information processing device operated by a user, such as a portable information terminal, a stationary computing device, or any other communication-capable device, that captures or stores images and transmits prompt sentences and other data to a server system.

The term “communication network” refers to a wired or wireless data transmission infrastructure, including local networks, wide area networks, and global networks, that enables data exchange between the terminal device and the server.

The term “transaction-related proof information” refers to information that evidences a commercial or service-related transaction, including but not limited to receipts, invoices, tickets, and vouchers, which may be represented as image data or derived structured data.

The term “image of a transaction document” refers to digital image data representing at least a portion of a document that proves a transaction, the image data being acquired by an imaging device or converted from another digital source.

The term “storage region” refers to a logical or physical memory area, such as a file system, storage device, or external storage service, in which image data and related information are stored persistently or semi-persistently.

The term “information management region” refers to a logical data storage structure, such as a database or data store, that maintains structured information in a form suitable for indexing, querying, aggregation, and updating by a processor.

The term “character recognition processing” refers to a sequence of operations that analyzes image data and converts visual patterns corresponding to characters or symbols into digital text information using optical character recognition or similar technology.

The term “structured information” refers to information represented in a predefined format with identifiable fields or attributes, such as records with individual items for date, amount, and entity name, which can be processed using database or programmatic operations.

The term “transaction date-time information” refers to structured information representing a time point or time period at which a transaction occurred, expressed in a machine-processable format such as a timestamp or standardized date representation.

The term “transaction amount information” refers to structured information representing a numerical value corresponding to a monetary or quantity amount associated with a transaction, optionally including a related currency or unit.

The term “transaction entity information” refers to structured information representing an entity associated with a transaction, such as a service provider, a commercial organization, or another party involved in the transaction.

The term “text information” refers to information expressed as a sequence of characters, symbols, or strings that has been obtained from image data through character recognition processing or other text acquisition methods.

The term “format analysis processing” refers to processing that analyzes the arrangement, syntax, or pattern of text information to detect formats such as dates, numerical values, and names, and to segment the text into meaningful components.

The term “pattern recognition processing” refers to processing that identifies recurring character patterns, numeric patterns, or lexical patterns in text information in order to classify or extract specific types of data, such as dates, amounts, or entity names.

The term “standardized date information” refers to date-related information that has been converted into a uniform representation, such as a fixed-format string or timestamp, enabling consistent comparison, sorting, and aggregation by a processor.

The term “standardized numerical amount information” refers to amount-related information that has been converted into a normalized numerical representation, with a consistent unit or currency and numeric type suitable for arithmetic operations.

The term “standardized entity name information” refers to entity-related information that has been normalized or canonicalized, for example by resolving variations, abbreviations, or spelling differences into a common representation for an entity.

The term “attribute item” refers to a unit of structured information corresponding to a specific field or property, such as a date field, an amount field, or an entity name field, stored as part of a record in the information management region.

The term “prompt sentence” refers to a natural-language input expressed as one or more sentences provided by a user to request information, analysis, or an explanation from a system that includes a generative AI model.

The term “query intent” refers to an interpretation of a prompt sentence that identifies the underlying request of the user, including at least the target data range, aggregation objectives, and classification or filtering conditions.

The term “target period information” refers to information specifying a time interval to which a query or aggregation operation is to be applied, such as a particular day, month, or range of dates.

The term “aggregation condition information” refers to information defining how structured data should be combined or summarized, such as summing amounts, counting occurrences, or grouping by entities or periods.

The term “aggregation processing” refers to processing that computes summary values over multiple data items, such as sums, counts, averages, minima, maxima, or other aggregate metrics applied to structured information.

The term “classification processing” refers to processing that organizes or partitions structured information into categories or groups, such as grouping by entity, date, or transaction type based on attribute values.

The term “numerical information” refers to information represented by numeric values derived from structured data, such as aggregated amounts, counts of records, or computed statistics related to transactions.

The term “input context” refers to a composite set of information provided as input to a generative AI model, including at least a prompt sentence and associated structured or numerical information related to the prompt sentence.

The term “generative AI model” refers to a computational model, typically implemented as a machine-learned neural network, that generates natural-language text or other content in response to input context including prompt sentences and structured data.

The term “response sentence” refers to one or more natural-language sentences generated by the generative AI model based on the input context, intended to answer, explain, summarize, or analyze information in response to a prompt sentence.

In some embodiments, a server implements the claimed system using a hardware configuration that includes at least one processor, a main memory, a non-volatile storage device, and a network interface. The server optionally uses a graphics processing unit or a dedicated accelerator for neural network inference. The server executes an operating system and application software including a web server module, an image processing module, an optical character recognition module, a database management system, and a generative AI model interface module.

The server cooperates with at least one terminal and at least one user. The terminal includes an imaging device such as a digital camera, a processor, a display, an input interface, and a communication interface. The terminal executes a browser application or a native application that provides a user interface for capturing transaction documents, transmitting images, and displaying natural-language responses. The user operates the terminal to provide images and prompt sentences and to review responses returned from the server.

The server acquires transaction-related proof images from the terminal as digital information. The terminal uses camera hardware to capture an image of a transaction document, such as a receipt or ticket, and encodes the image as a raster image file such as a JPEG or PNG. The terminal transmits the encoded file to the server via a communication network using a secure protocol. The server receives the file and stores the image in a storage region, such as a file system on a solid-state drive or a network-attached storage device.

The server performs character recognition processing on the stored image using an OCR engine. In one embodiment, the server uses OCR software of the type commercially available as an open-source engine configured to run on a central processing unit. The server decodes the image into a pixel matrix using an image library such as a general-purpose image processing framework, converts the image to grayscale, applies binarization, and may perform deskewing and noise reduction. The server then passes the processed pixel data to the OCR engine together with language configuration parameters. The OCR engine executes a sequence of convolutional and recurrent operations on the pixel data to identify glyphs and map them to character codes, and outputs text information and layout information.

The server parses the OCR output using a text processing component. The server stores the raw OCR text in a buffer and applies format analysis processing and pattern recognition processing. The server uses regular expression libraries and dictionary-based lookup to detect candidate patterns corresponding to dates, amounts, entity names, and other attributes. The server converts identified substrings into standardized date information by parsing them into internal timestamp structures, and converts amount substrings into normalized numerical values using fixed-point representation with associated currency codes. The server performs normalization of entity names by applying string similarity metrics, such as edit distance or token-based similarity, against a reference list of known provider entities and by mapping variations to canonical identifiers.

The server registers the normalized attributes in an information management region implemented as a relational database. The server uses a database engine such as a structured query language database system running on the same hardware or on a separate database server. The server represents each transaction as a record with attribute items such as user identifier, transaction date-time, transaction amount, currency, entity identifier, image path, and OCR status. The server creates relational indexes on the date-time field, the entity identifier field, and the user identifier field to support efficient search and aggregation.

The server uses this specific data structure and indexing strategy to improve technical performance. Because the server converts unstructured OCR text into standardized attribute items before storing them, subsequent queries do not require repeated parsing of raw text. Instead, the server executes index-based range scans and group operations at the database level. This reduces central processing unit load, minimizes memory allocations for temporary parsing, and shortens response time when processing large numbers of receipts.

The user provides natural-language prompt sentences from the terminal. The terminal displays a text input field and transmits the entered text to the server together with a user identifier and authentication information. The server receives each prompt sentence and interprets the content using a specialized query-intent module. The server uses a combination of rule-based parsing and a lightweight natural-language understanding model to identify target period information, aggregation condition information, and filtering conditions.

In one embodiment, the server tokenizes the prompt sentence, applies part-of-speech tagging, and detects temporal expressions and quantitative expressions by reference to a domain-specific grammar. For example, when the user enters “Tell me the total taxi expenses for October 2023,” the server recognizes “October 2023” as a temporal expression and interprets it as a date range from the first day to the last day of the month. The server interprets “total” as an aggregation instruction to compute a sum and recognizes “taxi expenses” as a filter condition related to a subset of entities classified as transportation by taxi.

The server uses this interpreted query intent to construct one or more database queries. The server generates parameterized structured queries that select records from the information management region where the user identifier matches, where the transaction date-time falls within the identified period, and where the entity identifier belongs to a class associated with the requested category. The server executes aggregation processing such as sum, count, and average using database functions. The server may execute classification processing by grouping records according to entity identifier or date. The server thereby obtains numerical information and structured summary information without invoking a generative AI model for basic arithmetic.

The server constructs an input context for a generative AI model using the prompt sentence and the retrieved structured information. The server forms a context string or structured representation that includes the original prompt sentence, a concise machine-readable summary of the aggregation results, and optional explanatory metadata such as the applied filters and date range. The server then supplies this input context to a generative AI model that executes on a dedicated inference module.

In one embodiment, the server uses a transformer-based neural network configured as a generative AI model. The server stores model parameters in a model storage region and loads the model onto a graphics processing unit or other accelerator at runtime. The neural network may have multiple self-attention layers, feedforward layers, and positional encoding mechanisms. The server can use a pre-trained language model fine-tuned on domain-specific financial and transportation data. During fine-tuning, the server (or a training environment associated with the server) optimizes the model parameters by minimizing a loss function such as cross-entropy between predicted tokens and ground-truth tokens, using gradient descent and backpropagation. The server may apply data augmentation methods including paraphrasing prompt sentences and generating synthetic question-answer pairs from structured transaction data to improve robustness.

The server uses the generative AI model in a constrained manner. The server does not delegate numerical aggregation or database search to the model. Instead, the server supplies pre-computed numerical information and standardized attributes as part of the input context, and instructs the model to generate a natural-language response sentence that explains, summarizes, or analyzes that information. For example, when the user issues the prompt sentence “Tell me the total taxi expenses for October 2023,” the server computes the total amount using the database engine and includes a summary such as “Total taxi expenses: 320 units for October 2023; 18 receipts; top entities: Entity A, Entity B” in the input context. The generative AI model then generates a response such as “Your total taxi expenses for October 2023 are 320 units, based on 18 trips. The most frequently used providers are Entity A and Entity B.”

The server achieves technical improvements by this division of responsibilities. Because the server uses relational database operations for deterministic aggregation and uses the generative AI model only for language generation conditioned on structured data, the system reduces inference load on the neural network, shortens overall processing time, and lowers the probability of inconsistent or hallucinated numerical results. The server improves computational efficiency and reliability relative to a system that would rely solely on a generative AI model operating on unstructured data.

The server further improves accuracy and robustness by implementing specific rules and non-conventional processing steps for receipt normalization. The server applies heuristic rules and threshold-based criteria to evaluate OCR confidence scores and to request re-processing when confidence falls below a threshold. The server may run the OCR engine multiple times with different binarization parameters and select the result with the highest aggregate confidence. The server may also enforce internal consistency rules, such as verifying that the sum of line items matches the total amount within a numerical tolerance, and may correct individual fields when a discrepancy is detected. These rules and tolerance-based corrections are implemented as deterministic algorithms that operate on the OCR output and the structured attributes, providing an improvement in data quality over simple single-pass OCR.

The terminal and the server cooperate to provide real-time interaction with reduced communication overhead. The terminal sends only compressed images and concise prompt sentences to the server, and receives only textual responses and optional small metadata. The server does not stream large intermediate representations or full model activations to the terminal, thereby reducing network bandwidth usage. When the user issues follow-up prompt sentences such as “Which day in October 2023 had the highest taxi cost?” the server reuses previously stored structured data and executes only incremental queries, instead of requesting the user to re-upload images or re-run OCR. This reuse of normalized data reduces redundant data transmission and computation.

The server can implement multiple alternative embodiments. In one embodiment, the information management region is a relational database. In another embodiment, the server uses a column-oriented database or a key-value store optimized for time-series data, storing transaction date-time as a primary index and amount as a column for efficient aggregation. In yet another embodiment, the server partitions the database by user or by time range to improve scalability, and uses distributed query processing to aggregate results across partitions.

The server can use different character recognition engines, such as a recurrent neural network-based recognizer or a transformer-based vision-text model, provided that the output is text which can be parsed into attributes. The server can adjust preprocessing parameters depending on document type. For example, when processing transportation tickets with dense text, the server may apply adaptive thresholding and line segmentation; when processing receipts with large logos, the server may remove graphical areas before OCR. These variants improve recognition accuracy and therefore improve the quality of the structured data, which in turn enhances the reliability of the responses generated by the generative AI model.

The server may use different generative AI models. In one embodiment, the server calls an external inference service via an application programming interface. In another embodiment, the server runs an on-premises model using locally stored parameters. The server may select a smaller model for simple summarization requests and a larger model for complex analysis requests, based on characteristics of the prompt sentence and the size of the structured data to be described. This dynamic selection improves computational efficiency and reduces latency. The server can support various examples of prompt sentences, including but not limited to:
“Tell me the total taxi expenses for October 2023.”
“Show me a summary of my transportation expenses by provider for the last three months.”
“Which day in November 2023 had the highest total taxi cost, and how much was it?”
“Generate a short explanation I can attach to my expense report for my October transportation usage.”

For each such prompt sentence, the server interprets the query intent, retrieves relevant structured data, executes aggregation and classification at the database layer, and then invokes the generative AI model with an input context that includes both the prompt sentence and the derived structured information. The server thereby provides a consistent processing pipeline in which each technical module—OCR, normalization, database storage, query interpretation, aggregation, and generative language output—performs a specialized function. The server improves computer technology itself by modifying how image-based receipt data and natural-language queries are handled. Instead of treating each user request as a separate, unstructured processing task, the server builds and maintains a normalized, indexed representation of transaction data. This enables faster, more accurate responses to successive queries. The server also introduces a specific integration pattern between database processing and a generative AI model, in which the model receives constrained, pre-validated inputs and is used primarily for human-readable explanation. This architecture reduces the need for repeated parsing and ad hoc string operations, reduces the incidence of numerical errors, lowers processing time per query, and reduces computing resource consumption, thereby providing a concrete technical effect beyond simple automation of manual analysis.

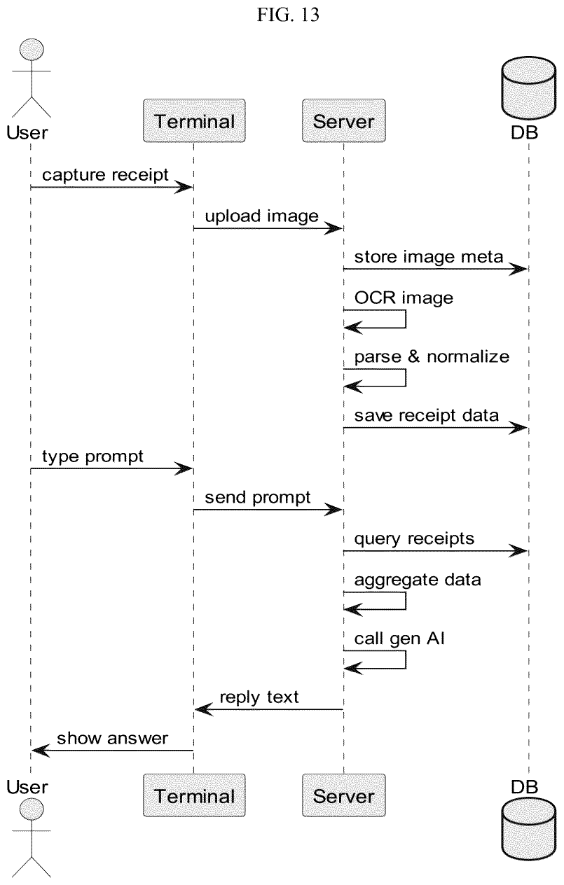

The following describes the processing flow using FIG. 13.
Step 1:

The user operates the terminal to capture a transaction document as an image.

The input is a physical transaction document such as a receipt or ticket.

The terminal activates an imaging device, converts the captured scene into digital pixel data, and encodes the data into an image file format such as JPEG or PNG.

The output is an image file stored temporarily in the terminal's local memory.
Step 2:

The terminal transmits the image file to the server via a communication network.

The input is the locally stored image file and user identification information.

The terminal establishes a secure connection, encapsulates the image bytes and user identifier into a message, and sends an upload request to a server endpoint.

The output is a network message containing the image file and metadata received by the server.
Step 3:

The server stores the received image file in a storage region.

The input is the uploaded image file and associated metadata.

The server assigns a unique storage path or object key, writes the raw image bytes to a non-volatile storage device, and registers a preliminary record that links the user identifier to the storage path.

The output is a stored image file and a corresponding metadata entry indicating that the image is available for processing.
Step 4:

The server decodes and preprocesses the stored image for character recognition.

The input is the stored image file referenced by the storage path.

The server uses an image processing library to load the image, convert it to a pixel matrix, perform grayscale conversion, binarization, noise reduction, and optional deskewing to correct rotation.

The output is a preprocessed image representation in memory suitable for optical character recognition.
Step 5:

The server executes character recognition processing on the preprocessed image.

The input is the preprocessed pixel matrix representing the transaction document.

The server invokes an OCR engine, which analyzes local pixel neighborhoods, segments text lines and characters, applies trained recognition models, and maps visual patterns to character codes.

The output is text information and layout information representing the characters detected in the image.
Step 6:

The server parses the OCR output into candidate attribute strings.

The input is the raw text information and layout metadata produced by the OCR engine.

The server applies tokenization, line segmentation, and regular expressions to isolate substrings likely corresponding to dates, amounts, and entity names, using pattern matching rules and positional hints from the layout.

The output is a set of candidate strings tagged as potential date values, amount values, and entity name values.
Step 7:

The server normalizes and validates the candidate attribute strings.

The input is the set of candidate strings with associated tags.

The server converts date strings into standardized date-time formats using date parsing algorithms, converts amount strings into numeric values with consistent precision and currency, and resolves entity names against a canonical list using similarity metrics and threshold-based selection.

The output is a set of validated and standardized attributes for each transaction, including transaction date-time information, transaction amount information, and transaction entity information.
Step 8:

The server registers the standardized attributes in an information management region.

The input is the set of standardized attributes and the linkage to the original image metadata.

The server forms a structured record with fields such as user identifier, transaction date-time, numerical amount, currency, entity identifier, and image reference, and inserts the record into a database table using structured queries.

The output is a persistent structured data record indexed for later querying and aggregation.

Step 9:

The server updates index structures for efficient access to the structured data.

The input is the new or updated record in the database.

The server updates or creates indexes on key fields such as user identifier, transaction date-time, and entity identifier, enabling logarithmic-time lookup and efficient range scans during future queries.

The output is a database state in which the new record can be retrieved and aggregated with reduced processing time.
Step 10:

The user operates the terminal to open a query interface and enter a prompt sentence.

The input is the user's information need regarding transaction data.

The terminal displays a text input field, accepts keystrokes or speech-to-text results, and forms a natural-language prompt sentence such as “Tell me the total taxi expenses for October 2023.”

The output is a text string representing the prompt sentence available for transmission to the server.
Step 11:

The terminal transmits the prompt sentence to the server.

The input is the prompt sentence and user identification information.

The terminal encapsulates the prompt sentence in a request message, includes authentication data, and sends the message to a server endpoint dedicated to natural-language queries.

The output is a request message containing the prompt sentence received by the server.
Step 12:

The server interprets the prompt sentence to determine query intent.

The input is the prompt sentence and the user identifier.

The server tokenizes the sentence, applies linguistic analysis to detect temporal expressions, aggregation keywords, and category terms, and maps them to internal parameters such as a date range, aggregation type (for example, sum or count), and entity filters (for example, taxi-related entities).

The output is a query intent representation that specifies target period information, aggregation condition information, and filter conditions.
Step 13:

The server retrieves relevant structured records from the information management region.

The input is the query intent representation and the database containing structured transaction records.

The server constructs parameterized database queries that select records matching the user identifier, falling within the target period, and satisfying the filter conditions, and executes these queries using the database engine.

The output is a set of structured records corresponding to the transactions relevant to the user's prompt sentence.
Step 14:

The server performs aggregation and classification on the retrieved records.

The input is the set of relevant structured records.

The server applies aggregation functions such as sum, count, and average to the amount fields and may group the records by entity identifier or date to generate subtotals and distributions, leveraging database-level group operations or in-memory aggregation routines.

The output is numerical information and structured summaries, such as total amount, number of transactions, and per-entity or per-day breakdowns.
Step 15:

The server constructs an input context for a generative AI model.

The input is the original prompt sentence and the aggregated and classified structured information.

The server formats the numerical results and key attributes into a concise context description, combines this description with the prompt sentence into a single sequence or structured input, and includes instructions that constrain the generative AI model to describe the provided data rather than infer new values.

The output is a model input context containing both the user's natural-language query and machine-computed transaction summaries.
Step 16:

The server executes inference using the generative AI model to generate a response sentence.

The input is the constructed model input context.

The server loads the generative AI model parameters, computes token embeddings for the context, propagates these embeddings through multiple attention and feedforward layers to predict subsequent tokens, and generates a sequence of natural-language tokens that form a coherent response.

The output is a response sentence or set of sentences that explain, summarize, or analyze the transaction data in natural language.
Step 17:

The server post-processes the generated response sentence for delivery.

The input is the raw token sequence or text produced by the generative AI model.

The server converts tokens into characters, removes extraneous markers, enforces language and formatting constraints, and verifies that numerical values referenced in the text match the aggregated data, correcting mismatches if necessary by replacing numbers with database-derived values.

The output is a finalized response sentence ready to be sent to the terminal.
Step 18:

The server transmits the finalized response sentence to the terminal.

The input is the finalized response text and the user identifier.

The server encapsulates the response in a message, associates it with the corresponding query session, and sends it over the communication network to the terminal.

The output is a network message containing the natural-language response delivered to the terminal.
Step 19:

The terminal displays the response sentence to the user.

The input is the response sentence received from the server.

The terminal parses the message, renders the text within a user interface component such as a chat bubble or result area, and optionally provides controls for the user to issue follow-up prompt sentences based on the displayed result.

The output is a visual presentation of the response sentence on the terminal display.
Step 20:

The user optionally issues a follow-up prompt sentence based on the displayed response.

The input is the information shown in the response sentence.

The user reviews the explanation or summary and formulates an additional prompt sentence, such as “Which day in October 2023 had the highest taxi cost?” or “Show me a summary of my transportation expenses by provider for the last three months.”

The output is a new prompt sentence that can be reintroduced into the same processing flow beginning from the transmission of the prompt sentence to the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional receipt-processing and claim-handling systems typically perform optical character recognition on receipt images and then forward extracted transaction data to back-end business applications. However, such systems suffer from several technical limitations in the way computing resources are utilized and in how data is generated, structured, and routed. First, existing architectures generally treat OCR output as static text and rely on rigid, rule-based workflows executed by the processor. These workflows lack a mechanism to dynamically adjust request payloads or control flows based on higher-level inferences, such as a user's emotional state. As a result, the processor must either implement complex and brittle rule sets, or send uniform, context-agnostic requests to external processing apparatuses, which leads to redundant network traffic, inefficient use of external services, and an inability to prioritize or tailor processing.

Second, conventional systems handle receipt data and user feedback data in separate, loosely coupled subsystems. User voice and facial data, when collected, are often processed independently from transaction data and are not integrated into the same data structures or communication paths. This fragmentation forces the processor to perform multiple disjoint data lookups and transmissions, increases memory access overhead, and complicates data consistency and synchronization across heterogeneous devices and applications.

Third, while generative AI models are increasingly available as networked services, traditional systems do not exploit such models as part of the core control logic that generates structured auxiliary data and dynamically drives downstream processing. In many cases, generative models are used only at the user interface layer, not at the transaction-processing layer. Consequently, the processor cannot leverage the generative model's ability to synthesize emotion-aware metadata and routing decisions into machine-usable formats, such as structured additional information that can be directly consumed by external processing apparatuses.

Fourth, existing systems lack a standardized mechanism for expressing high-level processing intents to generative models in a form that the processor can systematically generate and consume. Without a defined structure for processing instruction sentences, interactions with generative models are ad hoc, resulting in non-deterministic outputs that are difficult to parse programmatically. This leads to additional parsing and validation overhead on the processor, and prevents reliable integration of generative outputs into transaction data pipelines.

Because of these limitations, the overall computer system—comprising the server, the user device, and external processing apparatuses—exhibits suboptimal performance and functionality: transaction and emotion data are not efficiently fused; network and processor resources are not effectively prioritized; and the system cannot automatically adapt application content or processing requests based on user emotion in a consistent, machine-readable manner. There is therefore a need for an improved computer-implemented system and method in which a processor integrates receipt imaging, OCR, emotion analysis, and generative AI-based control into a unified pipeline, thereby improving how data is structured, routed, and used to control external processing in an emotion-aware and computationally efficient manner.

The specific processing by the specific processing unit 290 of the data processing device 12 in Application Example 2 is realized by the following means.

The present invention provides a server comprising a processor and a memory storing instructions that, when executed by the processor, cause the processor to acquire image-based evidence as digital information and store the digital information in a predetermined storage area, to apply optical character recognition technology to stored evidence images to extract information including at least a transaction date, a transaction amount, and a transaction party name and to generate structured information based on the extracted information, to generate electronic communication information for transmission to an external processing apparatus using the structured information and the evidence images and to transmit the electronic communication information to the external processing apparatus via a communication interface, to acquire user voice information and user facial information through an input interface, to generate emotion information indicating an emotional state from the user voice information and the user facial information, to execute a generative information processing model by inputting a processing instruction sentence to the generative information processing model so as to generate additional information including at least the structured information and the emotion information and to obtain the additional information in a structured machine-readable format, to dynamically adjust application content or processing request content to be transmitted to the external processing apparatus on the basis of the additional information, and to generate response information to be presented to a user on the basis of the emotion information and the additional information and to output the response information to a user device. This enables the computer system to integrate receipt data and emotion data into unified structured datasets, to use a generative AI model driven by explicit processing instruction sentences as a programmable control component for generating additional information that governs downstream processing, to reduce reliance on rigid rule-based logic by dynamically tailoring transaction-related requests and payloads to external processing apparatuses based on inferred emotional states, to decrease redundant network and processor usage by routing and prioritizing claim, preferential, or normal processing in accordance with emotion-aware additional information, and to improve overall computer functionality by providing an emotion-adaptive, generative-model-controlled data processing pipeline for receipt handling and related application processing.

The term “image-based evidence” refers to information representing a transaction or event that has been captured as a digital image, including but not limited to images of receipts, vouchers, invoices, tickets, or other documentary records of economic activity.

The term “digital information” refers to information encoded in a machine-readable format suitable for processing, storage, and transmission by computing equipment, including data represented as binary files, image files, text strings, or structured data records.

The term “predetermined storage area” refers to a logical or physical region of a storage resource, such as a file system directory, a database table, or a cloud storage object space, that is designated in advance by configuration or program logic for storing particular categories of digital information.

The term “evidence image” refers to a digital image data file that visually represents image-based evidence and that is suitable for further analysis, including optical character recognition processing.

The term “optical character recognition technology” refers to a computational technique that analyzes image data to detect and recognize graphical representations of characters or symbols and converts them into corresponding machine-readable text data.

The term “structured information” refers to information that has been organized into a predefined format or schema, such as key-value pairs, records, or objects, enabling efficient programmatic access, storage, and transmission, for example in a markup or serialization format.

The term “transaction date” refers to temporal information indicating when a recorded transaction occurred, normalized into a consistent representation suitable for computation and comparison by a processor.

The term “transaction amount” refers to numerical information indicating a quantity of value, such as a monetary value associated with a transaction, optionally including a currency designation.

The term “transaction party name” refers to textual information identifying an entity involved in a transaction, such as a merchant, service provider, or other counterparty.

The term “electronic communication information” refers to digital data formatted for transmission over a communication network to a remote apparatus, the data including payload contents, headers, and control information required for the remote apparatus to process the transmitted data.

The term “external processing apparatus” refers to a computing resource separate from the server, such as a remote server, service platform, or application system, that receives electronic communication information and performs processing based on the received information.

The term “payment processing apparatus” refers to an external processing apparatus configured to perform operations related to financial settlement, such as authorization, capture, posting, or recording of payment transactions.

The term “expense management apparatus” refers to an external processing apparatus configured to store, categorize, reconcile, and report expenses or cost-related records for an individual or organization.

The term “transaction information” refers to structured information describing a transaction, including at least one of a transaction date, a transaction amount, a transaction party name, and an identifier or reference to associated evidence images.

The term “identification information of the evidence images” refers to information that uniquely identifies or locates an evidence image, such as a filename, a uniform resource locator, a database key, or another reference suitable to retrieve the image.

The term “user voice information” refers to digital data representing acoustic signals generated by a user, including audio recordings or processed features derived from such signals, which are suitable for analysis by a processor.

The term “user facial information” refers to digital data representing visual characteristics of a user's face, including images, video frames, or extracted facial feature data, which are suitable for analysis by a processor.

The term “emotion information” refers to data describing an inferred emotional state of a user, such as satisfaction, dissatisfaction, joy, anger, or neutrality, and optionally further including associated confidence values or scores.

The term “additional information” refers to information that is generated based on other underlying data, such as structured information and emotion information, and that augments or enriches such data with further classifications, explanations, or control-related metadata.

The term “generative information processing model” refers to a computational model, such as a machine-learned model, configured to generate new output data based on input data and instructions, the output including at least explanatory text, classifications, or structured metadata.

The term “processing instruction sentence” refers to a machine-readable natural language or semi-structured text string provided as input to a generative information processing model, the text string specifying at least a task, context, and output constraints that guide the model's generation behavior.

The term “application content” refers to data or parameters included in a request to an external processing apparatus, such as the type, scope, and detail of transaction-related operations to be executed.

The term “processing request content” refers to information defining instructions or parameters of a processing request directed to an external processing apparatus, including operation type, target record identifiers, and processing options.

The term “complaint processing” refers to a category of processing request content that instructs an external processing apparatus to handle a transaction in a manner designated for dissatisfaction or error handling, such as initiating a claim, dispute, or remedial action.

The term “preferential processing” refers to a category of processing request content that instructs an external processing apparatus to handle a transaction in a prioritized or beneficial manner, such as applying a discount, benefit, or special condition in favor of the user.

The term “normal processing” refers to a category of processing request content that instructs an external processing apparatus to handle a transaction according to default or standard processing rules without special complaint or preferential treatment.

The term “emotion classification result” refers to an output of a computational process that assigns at least one emotion label to a set of input data, such as user voice information or user facial information, in accordance with a predefined emotion taxonomy.

The term “reasoning information” refers to explanatory data that indicates a basis or rationale for a particular classification or decision, such as textual justification accompanying an emotion classification result.

The term “response information” refers to data generated for presentation to a user, including messages, notifications, or guidance, the content of which is determined based on underlying structured information, emotion information, or additional information.

The term “user device” refers to an information processing terminal operated by a user, such as a mobile communication device, a tablet, a personal computer, or another interactive terminal configured to display response information and capture user inputs.

In one embodiment, a server cooperates with a terminal and a user to implement the claimed system. The server includes at least one processor, a main memory, a non-volatile storage device, and a network interface. The terminal includes at least one processor, a camera, a microphone, a display, a local storage device, and a wireless communication interface. The user interacts with the terminal to capture image-based evidence and to provide voice and facial expressions that are processed by the server.

Server executes an application program stored in the memory. The application program is implemented, for example, as a set of software modules written in a general-purpose programming language and executed on an operating system running on a server-class machine. The server uses a local storage device or a network-connected storage service as the predetermined storage area for evidence images and structured data.

### 1. Hardware and Software Configuration for Receipt Imaging and Storage

Terminal captures image-based evidence such as a paper receipt, voucher, or ticket. Terminal uses the camera hardware with a camera driver provided by the operating system to obtain raw image sensor data and converts the raw data into a compressed digital image, for example a JPEG or PNG file. Terminal stores the image in local flash memory or other non-volatile memory and transmits the image over a wireless or wired network to the server via the communication interface.

Server receives the image through a web service component. Server uses a web framework such as a general web application framework to handle HTTP requests, and uses a storage library or an object storage client to store the received image file into a file system directory or network storage. Server registers a record in a database management system, such as a relational database, associating a record identifier with metadata including user identifier, upload time, and a path or object key pointing to the stored evidence image.

### 2. OCR Processing and Structured Information Generation

Server retrieves the stored evidence image from the predetermined storage area using the recorded path or object key. Server loads the image into memory using an image processing library. Server applies optical character recognition technology to the loaded image. In one embodiment, server invokes an OCR engine configured as a convolutional-recurrent neural network trained for character recognition. The OCR engine receives the image as an array of pixel intensities and performs the following internal processing:
A convolutional feature extractor applies multiple convolutional layers with fixed kernel sizes and strides to compute feature maps representing stroke patterns and character shapes. Each convolutional layer is followed by a non-linear activation function such as a rectified linear unit and a pooling operation that reduces spatial resolution.
A sequence encoder, implemented as a recurrent neural network or a transformer-based encoder, processes sequences of feature vectors derived from the convolutional feature maps along a horizontal axis to capture sequential dependencies among characters.
A classifier layer, implemented as a fully connected neural network with a softmax output, assigns probability distributions over character classes for each position in the sequence.
A decoding algorithm, such as a connectionist temporal classification beam search, determines the most likely character sequence in the presence of alignment uncertainty.

Server normalizes the OCR output by applying text post-processing operations. Server uses regular expressions and rule-based parsing to detect candidate date strings, amount strings, and transaction party strings. Server then converts detected date strings to a canonical date representation, converts detected amount strings to numeric values with associated currency codes, and matches transaction party strings to normalized entity names based on string similarity and configurable dictionaries.

Server generates structured information by constructing key-value records that include at least the transaction date, the transaction amount, and the transaction party name. Server stores these records in the database with a standardized schema, and links each record to the corresponding evidence image via the record identifier. By converting unstructured OCR text into standardized structured information at the server side, the system improves searchability and reduces redundant parsing operations for downstream processes, which improves processing speed and reduces memory access overhead compared to systems that repeatedly parse raw OCR text at multiple stages.

### 3. Emotion Information Acquisition and Feature Extraction

Terminal acquires user voice information and user facial information. Terminal records audio signals using the microphone with a sampling rate sufficient for speech analysis, and acquires a sequence of facial images or video frames using the camera oriented toward the user.

Terminal compresses audio and video data into digital files. In some embodiments, terminal performs preliminary feature extraction to reduce bandwidth requirements before transmission to the server.

Terminal computes acoustic features such as Mel-frequency cepstral coefficients, pitch contours, energy measures, and speaking rate over short time windows. Terminal packages these features into fixed-length vectors and discards raw audio, thereby reducing the amount of data sent to the server and improving privacy. Terminal also executes a face detection algorithm on the video frames to locate and crop the user's face, and then computes facial landmark coordinates and action unit intensities that describe facial muscle activations associated with emotional expressions.

Terminal transmits the computed acoustic feature vectors and facial feature vectors to the server over an encrypted communication channel. By transmitting compact feature representations rather than raw media streams, the system reduces network load and avoids redundant feature extraction on the server, which lowers computing resource consumption and improves latency.

### 4. Generative AI Model Architecture for Additional Information Generation

Server executes a generative information processing model stored in memory. In one embodiment, the generative information processing model is a transformer-based neural network that has been pre-trained on a large corpus of natural language text and then fine-tuned on task-specific data for emotion classification and reasoning. The model includes:
An embedding layer that converts input tokens into dense vector representations. Input tokens include subword units derived from natural language text and special tokens representing structured fields such as transaction date, transaction amount, and emotion scores.
Multiple self-attention layers, where each layer computes attention weights between all pairs of tokens to capture contextual relationships. Each attention layer includes a set of attention heads, linear projection matrices for queries, keys, and values, and a feed-forward network with non-linear activation functions.
A positional encoding mechanism that injects sequence position information into token embeddings.
An output layer that generates token probability distributions for natural language sequences and classification logits for predefined labels such as emotion classes.

Server constructs a processing instruction sentence as a natural language prompt sentence that explicitly describes the task to be performed, the available input data, and the required output format. Server concatenates the processing instruction sentence with serialized structured information and emotion feature summaries into a single text sequence. For example, a prompt sentence may be:

“You are an assistant that classifies customer emotions from text and transaction data. Receipt data: date=2023-10-15, amount=3000 JPY, merchant=Taxi Company. User comment: ‘This taxi was too expensive.’ Based on this, determine whether the user is satisfied or dissatisfied and explain the reason in one sentence. Respond in JSON with fields emotion_label and reason.”

Server tokenizes this sequence, feeds the tokens into the generative information processing model, and obtains output tokens. Server parses the output tokens to extract an emotion classification result and reasoning information in a structured machine-readable format. The model parameters, including attention weights and feed-forward layer weights, are updated during an offline training phase using supervised learning with a loss function such as cross-entropy loss for classification and language modeling loss for text generation. Model training includes gradient-based optimization, such as stochastic gradient descent with adaptive learning rate, and may use techniques such as dropout and data augmentation to improve generalization.

By using a transformer-based generative model controlled via precisely constructed processing instruction sentences, the system enables the server to generate additional information that simultaneously contains emotion classifications and contextual reasoning consistent with the structured transaction information. This approach differs from conventional rule-based expert systems because the model analyzes long-range dependencies across textual and structured fields and produces nuanced, machine-readable metadata, thereby improving classification accuracy and reducing the need for manually coded rules.

### 5. Dynamic Adjustment of Application Content and Processing Request Content

Server integrates the structured information, the emotion information, and the additional information into unified records. Server stores these records as composite data structures, for example as JSON documents, in the database. Each document includes fields representing the transaction information, the emotion classification result, the reasoning information, and links to the corresponding evidence images.

Server determines application content or processing request content to be transmitted to an external processing apparatus by applying a deterministic selection algorithm to the integrated record. For example, server uses the emotion classification result as an input to a finite-state decision module that selects one of complaint processing, preferential processing, or normal processing. Server then generates request payloads that include:
Transaction identifiers and structured transaction fields for normal posting operations;
Additional flags indicating dissatisfaction and descriptive reasoning when complaint processing is selected;
Discount or benefit parameters when preferential processing is selected.

Server transmits these payloads via a communication interface using secure network protocols. The structure of the payloads and control flags enables the external processing apparatus to prioritize certain transactions, allocate different resources, or trigger additional workflows. Because the decision logic is based on emotion-aware additional information produced by the generative model, the server can dynamically modify routing and prioritization without complex hand-written rule sets. This reduces branching complexity in the application code, improves maintainability, and allows the computer system to adapt processing behavior as model capabilities improve.

### 6. Response Information Generation and Terminal Interaction

Server generates response information for display to the user. Server constructs a second type of processing instruction sentence for the generative information processing model, which instructs the model to generate concise user-facing messages while incorporating the emotion classification result and planned processing action. For example, a prompt sentence may be: “You are a customer support assistant. The user just uploaded a taxi receipt: date=2023-10-15, amount=3000 JPY, merchant=Taxi Company. The user's emotion is ‘dissatisfied’ because they think the taxi was too expensive. Generate a short, polite English message apologizing and informing the user that they will receive a discount coupon for the next ride.” Server provides this prompt sentence and selected transaction fields to the model. Server receives a natural language message and formats it into response information that includes message text and optional structured fields such as a coupon identifier. Server sends the response information to the terminal.

Terminal receives the response information and updates its display. Terminal presents the message in a graphical user interface, such as a notification area or a detail screen for the corresponding transaction. Terminal may also update local state, such as caching the coupon identifier for offline use. By offloading language generation to the generative model while keeping the interaction strictly controlled by well-defined prompt sentences and structured outputs, the system improves user communication without requiring the terminal to store large language models locally, thus reducing memory requirements on the terminal.

### 7. Technical Effects and Improvements to Computer Technology

Server improves computer functionality in several ways. By converting unstructured OCR outputs into standardized structured information in a single central module, server reduces duplication of parsing logic and eliminates redundant data conversions in external processing apparatuses. This results in reduced processor cycles, lower memory consumption, and faster end-to-end transaction processing.

Server reduces network communication load by transmitting compact feature vectors from the terminal to the server instead of raw audio and video streams. This reduces bandwidth usage and transmission time, especially over mobile networks. The use of precomputed acoustic and facial features further reduces server-side CPU usage because the server can focus on classification and decision-making rather than media decoding and low-level feature extraction.

Server uses the generative information processing model not merely as a user interface enhancement but as a core decision component. The model produces additional information that includes structured emotion labels and reasoning, which drive downstream application content selection and processing request generation. Because the model internalizes complex contextual relationships between transaction attributes and user feedback, server can replace large rule sets with compact model parameters. During offline training, server optimizes these parameters using loss functions that reflect misclassification penalties and reasoning coherence, which directly improves the quality of structured metadata available for routing.

Server achieves improved accuracy in emotion classification by combining multimodal features (acoustic vectors and facial landmarks) and transaction context within the generative model prompt. This multimodal, context-aware analysis is not easily replicated by manual rules. The increased classification accuracy translates into fewer false complaint or preferential triggers, which, in turn, reduces unnecessary processing by external systems and improves resource allocation.

Server implements a non-conventional processing flow where receipt data and emotion data are integrated at the data structure level before being sent to external processing apparatuses. Instead of treating emotion analysis as a separate, user-interface-only feature, server embeds emotion metadata directly into transaction payloads. This architectural choice enables back-end systems to implement fine-grained prioritization and automated remedial actions based on machine-generated reasoning, which is not characteristic of mere automation of human decision-making.

Server applies learned parameters of the generative model to produce outputs that conform to machine-readable schemas dictated by the processing instruction sentences. The use of constrained prompts and post-processing logic ensures that outputs are predictable and easily parsed, which avoids non-determinism that would otherwise hinder integration. This design improves interoperability and reduces error handling and validation overhead, thereby improving the efficiency of the entire computing system.

### 8. Alternative Embodiments and Variations

In another embodiment, server uses a different neural network architecture for OCR, such as an attention-based encoder-decoder that directly maps image segments to text sequences. Server may also replace the transformer-based generative model with a recurrent neural network with attention, or with a hybrid model that uses a transformer encoder and a recurrent decoder. The essential requirement is that the generative information processing model accepts processing instruction sentences and structured fields as input and produces additional information suitable for downstream control.

In another embodiment, terminal performs more extensive processing on-device, including full OCR or preliminary emotion classification, and only transmits structured summaries to the server. Such an embodiment further reduces network load and allows the system to operate with limited connectivity, while server still executes the generative model to integrate terminal summaries with back-end transaction status.

In another embodiment, server uses different data storage technologies, such as a document-oriented database to store integrated records, or an in-memory key-value store to cache frequently accessed structured information and emotion metadata for low-latency operations.

In yet another embodiment, server uses different training datasets or loss functions for the generative model. For example, server may train the model with a multi-task loss that combines an emotion classification loss and a structure-conformance loss that penalizes deviations from required output schemas. By adjusting training parameters, server can emphasize classification accuracy or reasoning quality depending on application requirements.

Through these embodiments, server, terminal, and user cooperate to implement the system defined in the claims. The specific combination of OCR-based structured information generation, feature-based emotion analysis, generative-model-driven additional information generation using explicitly constructed prompt sentences, and dynamic adjustment of application content and processing request content provides a technical solution that improves how a computer system processes, stores, and routes transaction-related data, beyond mere automation of human tasks.

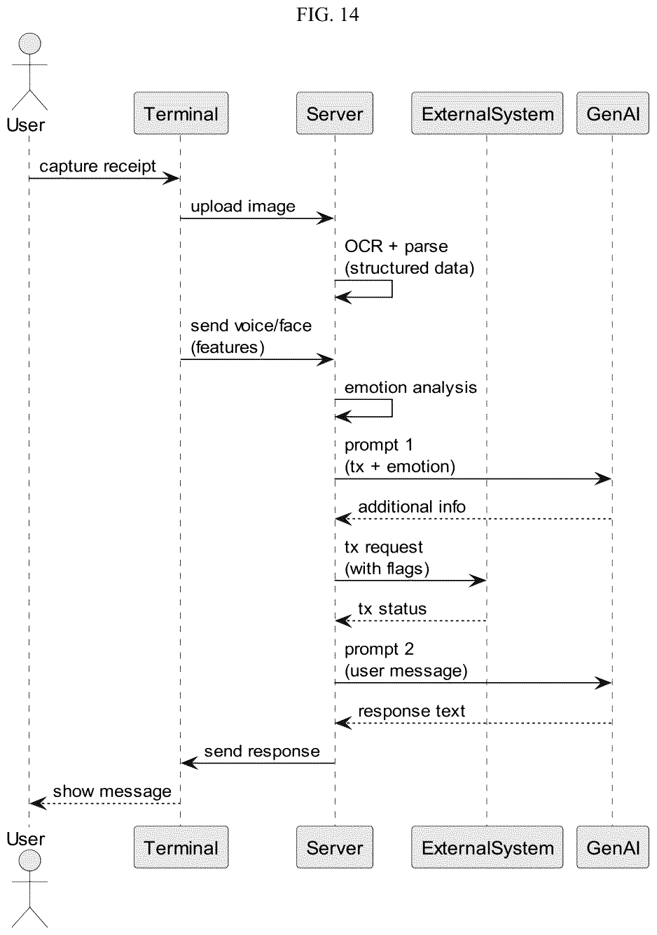

The following describes the processing flow using FIG. 14.
Step 1:

User operates the terminal to capture image-based evidence.

User holds a paper receipt in front of the terminal's camera and launches a dedicated application on the terminal.

Input: a physical receipt held by the user.

Terminal activates the camera hardware via the operating system's camera API and displays a live preview on the display. Terminal receives a capture command from the user (for example, via a shutter button), acquires raw image sensor data, and converts the raw data into a compressed digital image file such as a JPEG.

Output: a digital image file representing the receipt, stored temporarily in the terminal's local storage.
Step 2:

Terminal transmits the receipt image to the server.

Input: the digital image file stored in the terminal's local storage and metadata such as user identifier and capture time.

Terminal opens a secure network connection using a communication library and constructs an HTTP request addressed to an upload endpoint of the server. Terminal embeds the image file as multipart/form-data together with metadata fields, and sends the request over a wireless or wired network using a protocol such as HTTPS.

Output: an HTTP request containing the receipt image and metadata delivered to the server.
Step 3:

Server receives and stores the receipt image.

Input: the HTTP request containing the receipt image file and associated metadata.

Server executes a web service program that parses the HTTP request, extracts the binary image payload and the metadata, and validates the file type and size. Server generates a unique identifier for the receipt, such as a universally unique identifier, and writes the image file to a predetermined storage area, for example a directory on a storage device or an object in network storage. Server inserts a new record into a database table, storing the receipt identifier, user identifier, storage path, upload timestamp, and an initial processing status flag.

Output: a stored image file in the predetermined storage area and a corresponding database record referencing the file.
Step 4:

Server loads the stored image and performs optical character recognition.

Input: the receipt identifier and the storage location obtained from the database record.

Server retrieves the image file from the predetermined storage area and decodes it into an in-memory image representation using an image processing library. Server applies an optical character recognition engine to the image. The engine performs a sequence of data operations: it resizes and normalizes the image, extracts visual features via convolutional filters, encodes the sequence of features along text lines using a recurrent or encoder-decoder network, and decodes the features into a sequence of characters using a probabilistic decoding algorithm.

Output: a raw text string representing the characters detected in the receipt image.
Step 5:

Server parses OCR text and generates structured transaction information.

Input: the raw text string produced by the optical character recognition engine.

Server executes parsing routines that search the text for patterns matching dates, amounts, and party names using regular expressions and rule-based heuristics. Server converts detected date substrings into a standardized date format, parses numeric substrings associated with currency symbols into numerical amount values and separate currency codes, and normalizes merchant or service provider names by applying string matching against stored reference data. Server combines these normalized values into a structured record with fields such as transaction_date, transaction_amount, and transaction_party_name, and stores this record in the database linked to the receipt identifier.

Output: a structured transaction information object associated with the receipt identifier and stored in the database.
Step 6:

Terminal acquires user voice information during or after receipt capture.

Input: acoustic signals generated by the user, such as spoken comments about the transaction.

Terminal activates the microphone using an audio recording interface and samples the incoming analog audio signal at a defined sampling rate to produce digital audio samples. Terminal buffers these samples in memory for a preset duration and may compress them into an audio file format. Terminal may additionally compute acoustic feature vectors, such as spectral coefficients and pitch contours, by applying digital signal processing operations to sliding windows over the audio samples.

Output: a digital audio recording and, optionally, a set of acoustic feature vectors representing the user's voice.
Step 7:

Terminal acquires user facial information associated with the transaction.

Input: visual data of the user's face captured by the camera.

Terminal activates the front-facing camera, captures one or more frames of the user's face, and converts each frame into a digital image. Terminal executes a face detection algorithm to locate the face region, and then computes facial landmarks or other facial feature descriptors for emotion analysis. Terminal can discard the full-frame images after extracting the facial feature descriptors to reduce data size and preserve privacy.

Output: facial feature descriptors and, optionally, cropped face images associated with the receipt event.
Step 8:

Terminal transmits voice and facial features to the server.

Input: acoustic feature vectors, facial feature descriptors, and a reference to the receipt identifier.

Terminal packages the features into a compact data structure including the feature values, timestamps, and associated receipt identifier. Terminal opens a secure network connection and constructs an HTTP or other network protocol request addressed to an emotion-data endpoint on the server. Terminal sends the feature data to the server over the network.

Output: a network message containing multimodal user feature data delivered to the server.
Step 9:

Server generates emotion information from user feature data.

Input: acoustic feature vectors, facial feature descriptors, and the associated receipt identifier.

Server executes an emotion analysis module that applies machine learning models to the input features. Server feeds the acoustic feature vectors into a trained classifier, such as a neural network that maps vectors to emotion probability distributions, and feeds facial feature descriptors into a separate classifier or into a multimodal fusion layer. Server combines the outputs using a fusion algorithm, such as weighted averaging or a learned fusion network, to derive a final emotion label and associated confidence scores. Server constructs an emotion information object containing the emotion label and confidence values and stores the object in the database linked to the receipt identifier and user identifier.

Output: an emotion information object that describes the user's inferred emotional state in association with the receipt.
Step 10:

Server constructs a processing instruction sentence for a generative AI model.

Input: the structured transaction information, the emotion information, and any user comment text if available.

Server generates a textual prompt sentence that describes the task for the generative AI model, embeds key transaction fields such as transaction date, transaction amount, and transaction party name, and includes the computed emotion label or user comments. Server concatenates this information into a single natural language instruction that specifies the required output format, for example indicating that the output should contain an emotion classification result and reasoning.

Output: a processing instruction sentence formatted as a natural language prompt suitable for input to a generative AI model.
Step 11:

Server executes the generative AI model to produce additional information.

Input: the processing instruction sentence containing transaction information and emotion context.

Server encodes the prompt sentence into tokens using a tokenizer compatible with the generative AI model and forwards the tokens to a transformer-based generative model hosted locally or accessed through a model-serving interface. The model processes the input tokens through multiple self-attention layers and feed-forward layers, computing contextual representations, and then generates output tokens representing an emotion classification result and explanatory text. Server decodes the output tokens back into text, parses the text according to the requested output structure, and constructs an additional information object containing fields such as emotion_label and reason.

Output: an additional information object that includes at least an emotion classification result and reasoning information consistent with the transaction data.
Step 12:

Server determines application content and processing request content for an external processing apparatus.

Input: the structured transaction information, the emotion information, and the additional information object.

Server supplies these inputs to a decision module that implements selection logic for processing types. Server analyzes the emotion_label field and, in combination with confidence scores and transaction attributes, selects a category such as complaint processing, preferential processing, or normal processing. Server then constructs request content that includes transaction identification, structured transaction fields, and control parameters representing the selected category. Server packages these into an application payload for the external processing apparatus.

Output: a prepared application content payload and processing request content indicating how the external processing apparatus should handle the transaction.
Step 13:

Server transmits transaction payloads to the external processing apparatus.

Input: the application content payload and processing request content.

Server uses a communication interface to open a network connection to an endpoint of the external processing apparatus. Server serializes the payloads into a structured format, such as a JSON object embedded in an HTTP POST request, and includes authentication credentials in the headers. Server sends the request, waits for a response, and updates local database records with any identifiers or status codes returned by the external processing apparatus, such as confirmation of registration or completion.

Output: a request received and processed by the external processing apparatus and updated status information stored in the server database.
Step 14:

Server constructs a second processing instruction sentence to generate user-facing response information.

Input: the structured transaction information, the emotion information, the additional information object, and any status information returned from the external processing apparatus.

Server forms another natural language prompt that instructs the generative AI model to generate a concise and context-appropriate message for the user. Server embeds fields such as transaction date, transaction amount, merchant name, emotion_label, and selected processing category into the prompt, and specifies in the instruction that the message should, for example, apologize for dissatisfaction and inform the user of a discount in case of complaint processing.

Output: a second processing instruction sentence to be provided to the generative AI model.
Step 15:

Server generates response information for the user using the generative AI model.

Input: the second processing instruction sentence containing transaction and emotion context.

Server sends the prompt to the generative AI model, receives the generated text message as output, and encapsulates the message into a response information structure. Server may attach metadata such as a coupon identifier or link to a transaction detail view. Server records the response information in the database and marks it as pending delivery to the corresponding user.

Output: response information containing a user-facing message and any associated metadata.
Step 16:

Terminal receives and displays the response information to the user.

Input: the response information structure transmitted from the server.

Terminal opens a communication channel to retrieve pending response information for the user by providing a user identifier to the server. Terminal receives the response information, parses the message text and metadata, and updates the graphical user interface to display the message in a notifications area or within a transaction detail screen. Terminal may also update local records, such as storing a coupon identifier in a local wallet.

Output: a visual presentation of the response message on the terminal display, allowing the user to understand the outcome of the processing and any provided remedies or benefits.

The data generation model 58 is a so-called generative artificial intelligence (AI). Examples of the data generation model 58 include generative AIs such as ChatGPT (registered trademark) (Internet search <URL:https //openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

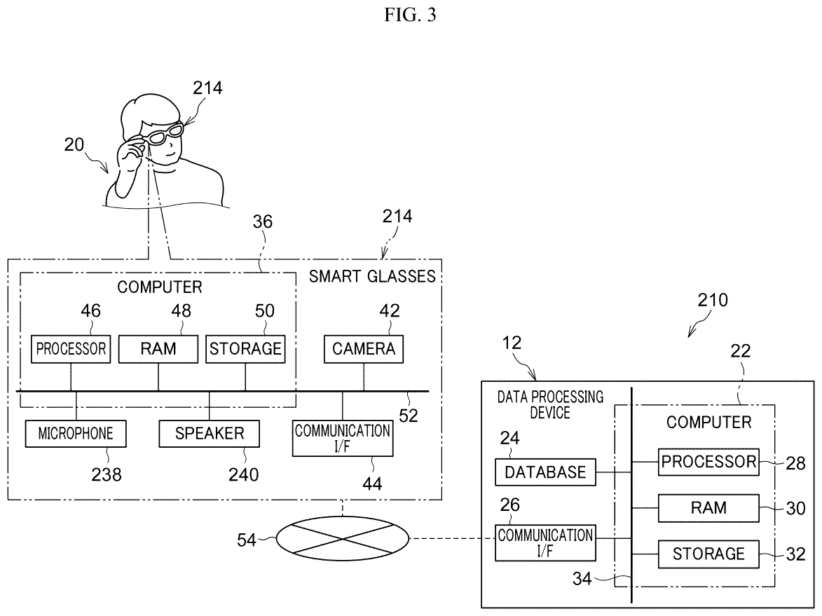

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

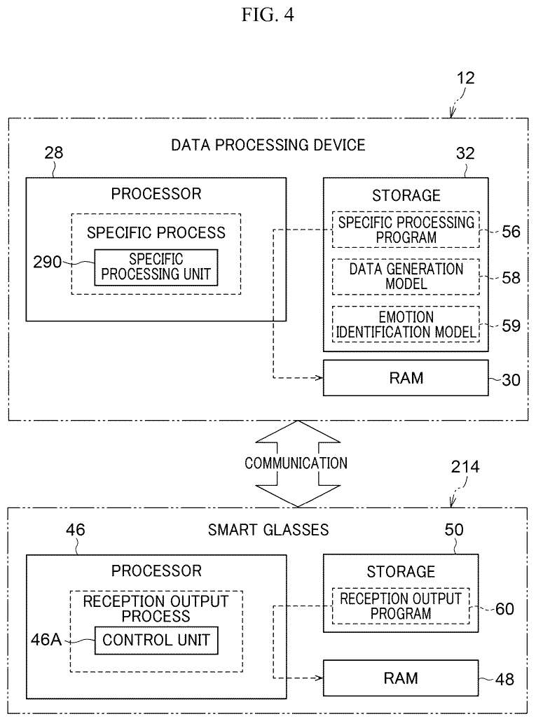

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

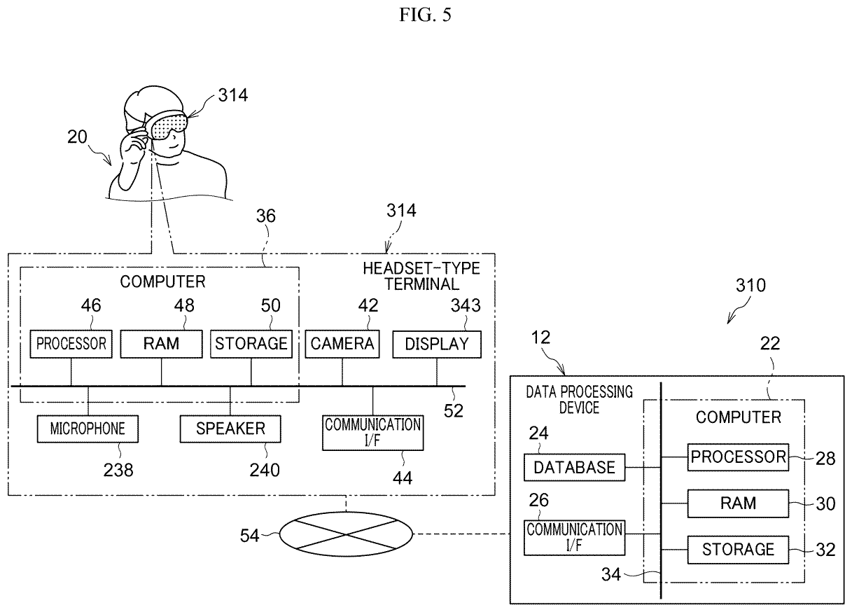

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

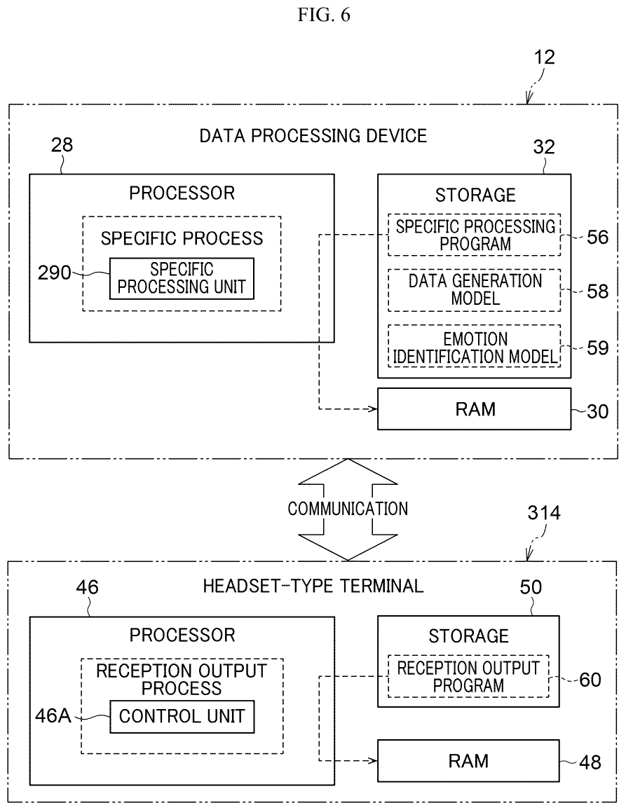

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

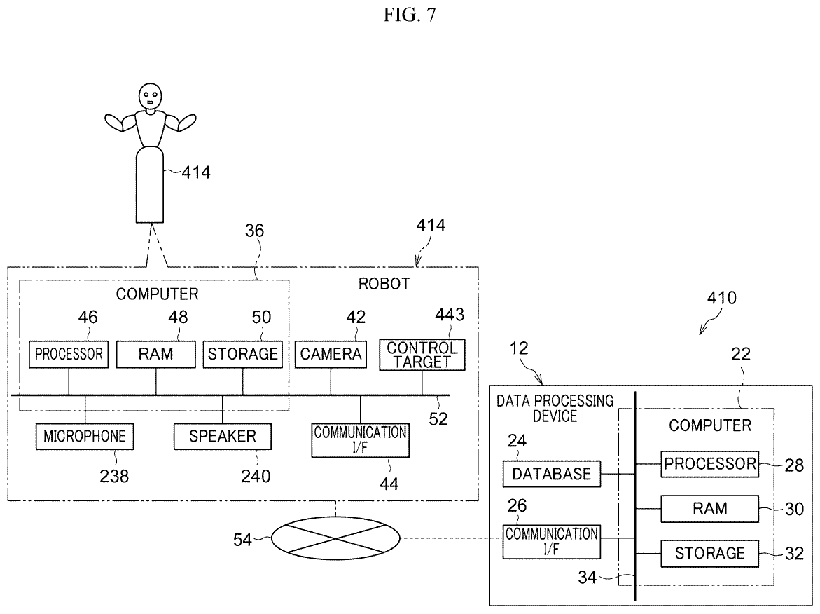

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

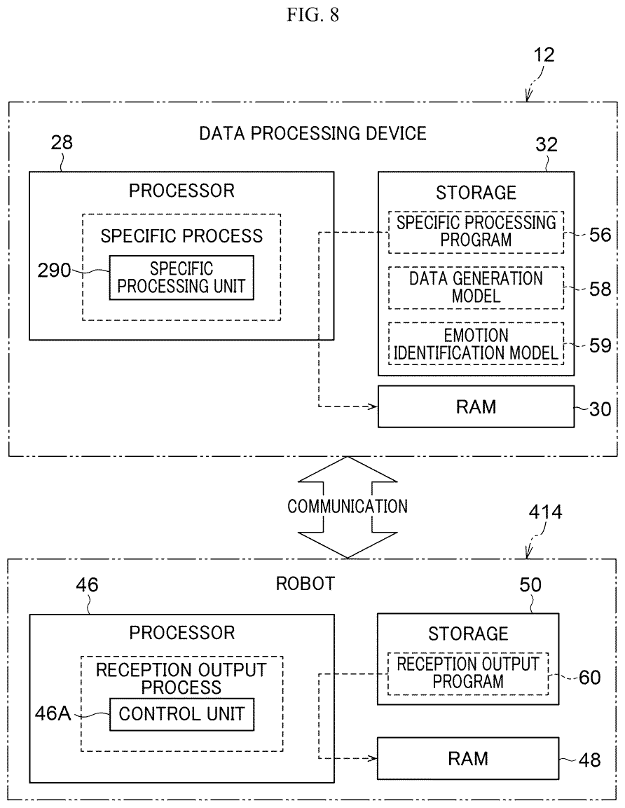

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

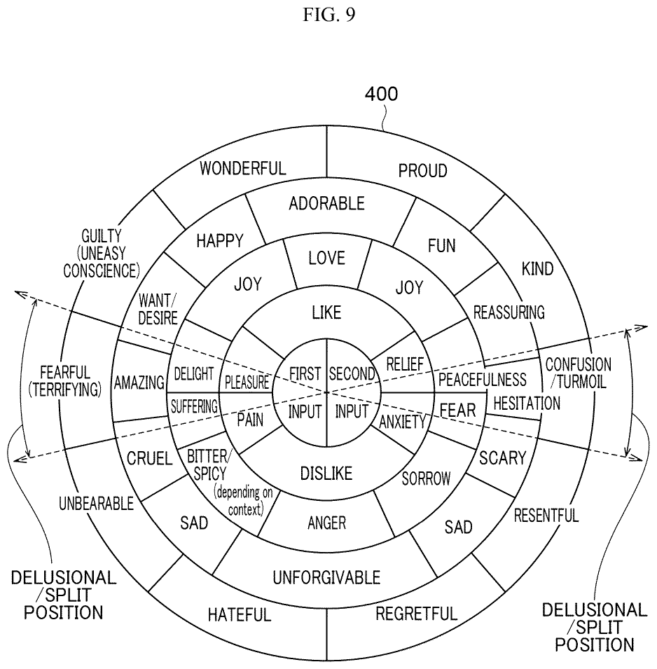

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

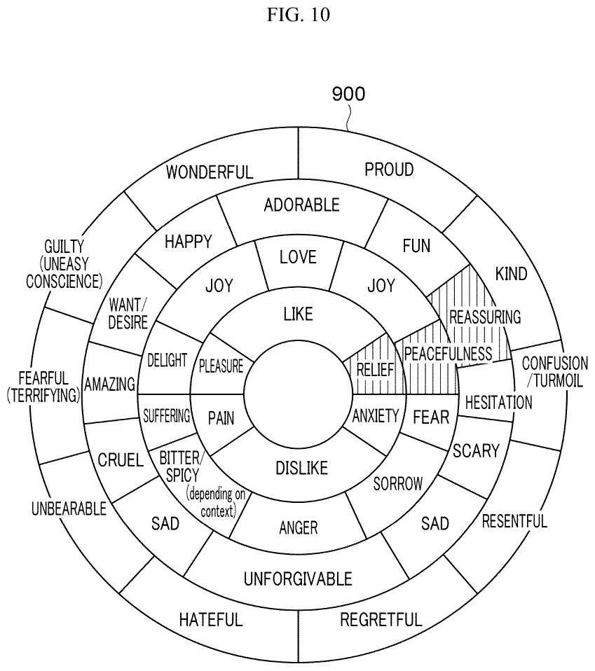

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from an input device, an imaged proof document as electronic data and store the electronic data in a predetermined storage region of a storage device,
perform preprocessing on the electronic data stored in the storage region, the preprocessing including at least normalization of image features, noise reduction processing, tone correction processing, and skew correction processing, so as to generate preprocessed electronic data suitable for character recognition,
execute optical character recognition processing on the preprocessed electronic data to extract character string information, and analytically extract item information including date information, numerical information, and name information from the character string information,
acquire voice information and facial expression information input from a user who has acquired the imaged proof document, convert the voice information and the facial expression information into feature information, and input the feature information to a generative artificial intelligence model for estimating an emotional state,
generate adjustment information for automatically correcting or changing application content on the basis of the emotional state estimated by the generative artificial intelligence model and the item information, and
integrate the item information, the preprocessed electronic data, and the adjustment information as structured data, convert the structured data into a data structure that is transmittable to an application processing device, and output the data structure.

### Supplementary 2

The System According to Supplementary 1,
wherein the processor is configured to
apply rule-based expression processing or statistical analysis processing to the character string information obtained by the optical character recognition processing, thereby automatically extracting date information, amount information, entity name information, and expense category information, and assign index information to the automatically extracted information to store the information as searchable record information.

### Supplementary 3

The system according to supplementary 1,
wherein the processor is configured to
generate a prompt sentence including an instruction relating to estimation of the emotional state and adjustment of the application content, input the prompt sentence to the generative artificial intelligence model, obtain, from the generative artificial intelligence model, a generation policy of the adjustment information or a candidate of an application statement, and update the application content included in the structured data on the basis of the obtained candidate.

### Application Example 1

### Supplementary 1

A system comprising a processor,
wherein the processor is configured to
acquire image information by optically reading transaction evidence recorded on a physical medium, converting the transaction evidence into electric signals, and storing the image information in a predetermined storage region of an information storage device,
apply an optical character recognition process to the image information stored in the storage region by using character recognition software, and extract character information and generate structured data including a transaction date, a transaction amount, and transaction counterpart identification information from the character information,
transmit the structured data to an external storage service via a communication line and cause the external storage service to store the structured data,
acquire the structured data from the external storage service, input the structured data into an information processing function of a business processing apparatus, convert the structured data into an internal data format for expense processing, and register the converted data as settlement information in an expense processing function,
display the settlement information registered in the expense processing function on a user terminal in response to an instruction from a user,
acquire voice information and expression information of the user from an input device, analyze the voice information and the expression information, estimate an emotional state of the user by using a generative artificial intelligence model, and adjust content or presentation of the settlement information based on the estimated emotional state, and
generate a data structure in which the image information of the transaction evidence and the structured data are associated with each other, and transmit the data structure to an application processing function.

### Supplementary 2

The system according to supplementary 1,
wherein the processor is configured to
execute image pre-processing including gradation conversion processing, noise reduction processing, and geometric correction processing on the image information prior to extraction of the character information by the character recognition software, so as to improve character recognition accuracy.

### Supplementary 3

The system according to supplementary 1,
wherein the processor is configured to
add attribute information including a user identifier, processing time information, and expense category information to the structured data when transmitting the structured data to the external storage service, and automatically classify the settlement information in the business processing apparatus based on the attribute information.

### Example 2

### Supplementary 1

A system comprising a processor,
wherein the processor is configured to
acquire transaction-related proof information as digital information by receiving an image of a transaction document from a terminal device via a communication network, and store the image in a storage region,
execute character recognition processing on the image of the transaction document stored in the storage region to extract structured information including transaction date-time information, transaction amount information, and transaction entity information, and register the structured information in an information management region,
obtain, from the terminal device, a prompt sentence in a natural language including inquiry content input by a user,
extract, based on the prompt sentence, target structured information from the information management region and input the structured information together with the prompt sentence into a generative AI model to cause the generative AI model to generate a response sentence, and
transmit the response sentence generated by the generative AI model to the terminal device for presentation to the user.

### Supplementary2

the system according to supplementary 1,
wherein the processor is configured to
execute format analysis processing and pattern recognition processing on text information obtained by the character recognition processing, and convert the text information into standardized date information, standardized numerical amount information, and standardized entity name information, while dividing the text information into a plurality of attribute items and registering the attribute items in the information management region.

### Supplementary 3

The system according to supplementary 1,
wherein the processor is configured to
extract target period information and aggregation condition information from the prompt sentence, execute aggregation processing and classification processing on the information management region based on the target period information and the aggregation condition information to obtain numerical information, integrate the numerical information with the prompt sentence as input context for the generative AI model, and cause the generative AI model to generate, as the response sentence, at least one of a natural-language explanatory sentence, a summary sentence, and an analytical result sentence.

### Application Example 2

### Supplementary 1

A system comprising a processor,
wherein the processor is configured to
acquire image-based evidence as digital information and store the digital information in a predetermined storage area,
apply optical character recognition technology to stored evidence images to extract information including transaction date, transaction amount, and transaction party name, and generate structured information based on the extracted information,
generate electronic communication information for transmission to an external processing apparatus using the structured information and the evidence images, and transmit the electronic communication information to the external processing apparatus,
acquire user voice information and user facial information,
generate emotion information indicating an emotional state from the user voice information and the user facial information,
execute a generative information processing model by inputting a processing instruction sentence to the generative information processing model so as to generate additional information including the structured information and the emotion information, and obtain the additional information,
dynamically adjust application content or processing request content to be transmitted to the external processing apparatus on the basis of the additional information, and
generate response information to be presented to a user on the basis of the emotion information and the additional information, and output the response information to a user device.

### Supplementary 2

The system according to supplementary 1,
wherein the processor is configured to
control the external processing apparatus that includes at least one of a payment processing apparatus and an expense management apparatus, and generate the electronic communication information such that the electronic communication information is registered as transaction information including the structured information and identification information of the evidence images in at least one of the payment processing apparatus and the expense management apparatus.

### Supplementary 3

The system according to supplementary 1,
wherein the processor is configured to
cause the additional information to include an emotion classification result and reasoning information for the emotion classification result, the additional information being generated on the basis of the processing instruction sentence input to the generative information processing model, and select the application content or the processing request content as one of complaint processing, preferential processing, or normal processing in accordance with the emotion classification result.

What is claimed is:

1. A system comprising:
circuitry configured to:
receive, via a communication interface coupled to a packet-switched network, image data representing a document from a terminal device and store the image data in a storage device;
apply optical character recognition processing to the image data to extract structured information comprising at least date information, numerical amount information, and entity identification information;
acquire, from the terminal device, audio signal data and facial image data associated with a user;
analyze the audio signal data and the facial image data to estimate an affective state of the user; and
transmit instruction data comprising the structured information and the estimated affective state to a generative model to cause the generative model to generate adjusted content data, the adjusted content data being conditioned on the estimated affective state.

2. The system according to claim 1, wherein the circuitry is configured to:
execute image preprocessing on the image data prior to the optical character recognition processing, the image preprocessing comprising at least one of gradation conversion processing, noise reduction processing, or geometric correction processing.

3. The system according to claim 1, wherein the circuitry is configured to:
convert the structured information into a standardized data format comprising standardized date information, standardized numerical amount information, and standardized entity name information.

4. The system according to claim 1, wherein the circuitry is configured to:
generate a data structure associating the image data with the structured information and the adjusted content data, and
transmit the data structure to an external processing apparatus via the communication interface.

5. The system according to claim 4, wherein the external processing apparatus comprises at least one of a settlement processing apparatus or a record management apparatus, and the data structure is registered as transaction information in the external processing apparatus.

6. The system according to claim 1, wherein the circuitry is configured to:
generate a prompt sentence comprising the structured information and the estimated affective state, and
transmit the prompt sentence to the generative model to obtain at least one of an adjustment policy or a candidate statement for inclusion in the adjusted content data.

7. The system according to claim 6, wherein the adjusted content data comprises at least one of supplemented explanatory text, modified categorization information, or corrected numerical information derived from the candidate statement.

8. The system according to claim 1, wherein the circuitry is configured to:
classify the estimated affective state into one of a plurality of affective categories, and
select, based on the affective category, a processing mode from a set of predefined processing modes for generating the adjusted content data.

9. The system according to claim 1, wherein the circuitry is configured to:
receive, from the terminal device, a natural-language query referencing the structured information stored in the storage device,
extract target structured information from the storage device based on the natural-language query, and
transmit the target structured information together with the natural-language query to the generative model to obtain a response sentence.

10. The system according to claim 9, wherein the circuitry is configured to:
extract target period information and aggregation condition information from the natural-language query,
execute aggregation processing on the storage device based on the target period information and the aggregation condition information to obtain numerical result data, and
transmit the numerical result data as input context to the generative model to generate at least one of an explanatory sentence, a summary sentence, or an analytical result sentence.

11. The system according to claim 1, wherein the circuitry is configured to:
add attribute information comprising a user identifier, time information, and category information to the structured information when storing the structured information in the storage device.

12. The system according to claim 1, wherein the circuitry is configured to:
transmit the structured information to an external storage service via the communication interface, and
acquire the structured information from the external storage service for input into a record processing function.

13. The system according to claim 1, wherein the generative model comprises a transformer-based language model, and the circuitry is configured to:
tokenize the instruction data into token sequences, and
transmit the token sequences to the transformer-based language model via the communication interface.

14. The system according to claim 1, wherein the circuitry is configured to:
generate response information to be presented to the user based on the estimated affective state and the adjusted content data, and
transmit the response information to the terminal device via the communication interface.

15. The system according to claim 1, wherein the circuitry is configured to:
store the image data, the structured information, and the adjusted content data as history data in the storage device, and
generate, from the history data, an input parameter for improving accuracy or relevance of subsequent adjusted content data generated by the generative model.

16. The system according to claim 1, wherein the terminal device comprises at least one of a mobile computing device, a wearable display device, a headset-type terminal, or a robotic apparatus, each coupled to the packet-switched network via the communication interface.

17. The system according to claim 16, wherein the terminal device comprises the wearable display device including a microphone and a speaker, and the circuitry is configured to:
receive the audio signal data from the microphone of the wearable display device, and
transmit audio output data to the speaker of the wearable display device.

18. The system according to claim 1, wherein:
the circuitry comprises a processor, a memory storing a program, a communication interface, and a storage device,
the processor executes the program to implement the optical character recognition processing and the analysis of the audio signal data and the facial image data,
the storage device stores the image data, the structured information, and the adjusted content data, and
the communication interface exchanges data with the terminal device over the packet-switched network.

19. The system according to claim 18, wherein the storage device comprises a record database that associates document identifiers with the structured information, affective state data, and adjusted content records.

20. A method performed by circuitry, the method comprising:
receiving, via a communication interface coupled to a packet-switched network, image data representing a document from a terminal device and storing the image data in a storage device;
applying optical character recognition processing to the image data to extract structured information comprising at least date information, numerical amount information, and entity identification information;
acquiring, from the terminal device, audio signal data and facial image data associated with a user;
analyzing the audio signal data and the facial image data to estimate an affective state of the user; and
transmitting instruction data comprising the structured information and the estimated affective state to a generative model to cause the generative model to generate adjusted content data, the adjusted content data being conditioned on the estimated affective state.
